(19) United States
(12) Patent Application Publication
(10) Pub. No.: US 2008/0228591 A1
(43) Pub. Date: Sep. 18, 2008

(54) Shopping system

(76) Inventors: Naoki WATANABE, Tokyo (JP); Syuichi TSUJIMOTO, Yokohama-shi (JP); Shigetoshi KUNIEDA, Kawasaki-shi (JP); Toru OKADA, Tokyo (JP); Kazuya NAMBU, Fujimino-shi (JP); Yasuhiro ONO, Kawasaki-shi (JP)

Correspondence Address: HARNESS, DICKEY & PIERCE, P.L.C., P.O. BOX 828, BLOOMFIELD HILLS, MI, 48303, US

(21) Appl. No.: 12/074,561

(22) Filed: Mar. 4, 2008

(30) Foreign Application Priority Data
Mar. 5, 2007 (JP) 2007-054837

(51) Int. Cl. G06Q 30/00

(52) U.S. Cl. 705/26

(57) ABSTRACT

When a merchandise identification code and a store identification code are received from mobile terminal, a merchandise server obtains merchandise information including the merchandise identification code from a merchandise information storage unit of a sales store specified by the store identification code. The merchandise server also obtains payment store information from a payment information storage unit of the sales store. The merchandise server generates an unused outstanding identification code and the merchandise server stores the merchandise information while relating the merchandise information to the outstanding identification code. The merchandise server sends back the outstanding identification code to the mobile terminal together with the payment store information. When a payment terminal makes a request for the outstanding identification code and merchandise information, the merchandise server transmits the merchandise information stored while related to the outstanding identification code to the payment terminal.

### CROSS-REFERENCE TO RELATED APPLICATIONS

This application is based upon and claims the benefit of priority from prior Japanese Patent Application No. 2007-054837, filed Mar. 5, 2007, the entire contents of which are incorporated herein by reference.

### BACKGROUND OF THE INVENTION

1. Field of the Invention

The present invention relates to a shopping system in which merchandise sold in a physical retail store can be purchased after closing time using a mobile terminal such as a cellular phone.

2. Description of the Related Art

Usually, in the physical retail store, merchandise can be purchased only during opening hours. Even if merchandise, which a consumer wants to purchase, is displayed in a store window in the shop, sometimes the merchandise cannot be purchased because of closing hours. Therefore, there is a need of the shopping system in which the merchandise sold in the physical retail store can be purchased outside opening hours.

For example, Jpn. Pat. Appln. KOKAI Publication No. 2006-209243 discloses a shopping system in which a consumer can purchase merchandise outside opening hours of a physical retail store. The shopping system includes a physical retail store, a virtual shop opened by an owner of the physical retail store, and a counter at which merchandise can be sold outside opening hours of the physical retail store. Using a mobile terminal, the consumer accesses the virtual store to purchase merchandise, for which an order is placed at the virtual store, at the counter.

However, in the shopping system disclosed in Jpn. Pat. Appln. KOKAI Publication No. 2006-209243, it is necessary that the operation is continued at the counter outside opening hours, which increases cost such as personnel expenses and utility costs.

### BRIEF SUMMARY OF THE INVENTION

Recently, 24-hour stores such as convenience stores are increasing in urban areas. Therefore, a consumer can purchase merchandise displayed in a store window outside the opening hours of a physical retail store. However, the consumer is enabled to pay for the merchandise in an active physical retail store such as the convenience store, which allows the expense to be reduced without losing convenience.

According to an aspect of the present invention, a shopping system comprises: a mobile terminal; a payment terminal; and a server which is connected to the mobile terminal and the payment terminal through a network.

The mobile terminal comprises: a payment communication unit which conducts data communication with the payment terminal; an input unit to which a merchandise identification code is input to identify merchandise; a transmission unit which transmits the merchandise identification code input through the input unit to the server; a reception unit which receives unique transaction identification code and payment store information transmitted from the server; a display unit which displays guide information of stores based on the payment store information received by the reception unit, payment for merchandise identified by the merchandise identification code input through the input unit being able to be performed in the stores; and a storage unit in which the transaction identification code received by the reception unit is stored.

The server comprises: a merchandise information storage unit in which merchandise information is stored while related to a merchandise identification code of each item of merchandise; a payment store information storage unit in which payment store information is stored, the payment store information indicating a stores in which payment for each item of merchandise can be performed; a merchandise information obtaining unit which obtains the merchandise information related to the merchandise identification code from the merchandise information storage unit, when the merchandise information obtaining unit receives the merchandise identification code from the mobile terminal; a code generation unit which generates the transaction identification code; a payment information retaining unit which retains the merchandise information obtained by the merchandise information obtaining unit while relating the merchandise information to the transaction identification code generated by the code generation unit; an outstanding information transmission unit which transmits the transaction identification code generated by the code generation unit to the mobile terminal together with the payment store information stored in the payment store information storage unit; a merchandise information detection unit which detects the merchandise information retained while related to the transaction identification code from the payment information retaining unit, when the merchandise information detection unit receives a request command of the merchandise information including the transaction identification code from the payment terminal; and a merchandise information transmission unit which transmits the merchandise information detected by the merchandise information detection unit to the payment terminal.

The payment terminal comprises: a mobile communication unit which conducts data communication with the mobile terminal; a mobile terminal information obtaining unit which obtains the transaction identification code stored in the mobile terminal through the mobile communication unit; a merchandise information request unit which transmits the request command of the merchandise information to the server, the merchandise information including the transaction identification code obtained by the mobile terminal information obtaining unit; and a payment processing unit which processes payment based on the merchandise information received from the server.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing a shopping system according to an embodiment of the invention;

FIG. 2 is a block diagram showing a configuration of a main part of a mobile terminal in the embodiment;

FIG. 3 shows a purchased merchandise list stored in a purchased merchandise area of the mobile terminal in the embodiment;

FIG. 4 shows a data structure of a record stored in a payment information management area of the mobile terminal in the embodiment;

FIG. 5 shows a data structure of a record stored in a transaction management area of the mobile terminal in the embodiment;

FIG. 6 is a block diagram showing a configuration of a main part of a payment terminal in the embodiment;

FIG. 7 shows an affiliated store list stored in an affiliated store management area of the payment terminal in the embodiment;

FIG. 8 shows a data structure of a record stored in a transaction information area of the payment terminal in the embodiment;

FIG. 9 is a block diagram showing a configuration of a main part of a user management server in the embodiment;

FIG. 10 shows a user list stored in a user ID management area of the user management server in the embodiment;

FIG. 11 is a block diagram showing a configuration of a main part of a store management server in the embodiment;

FIG. 12 shows a store list stored in a store ID management area of the store management server in the embodiment;

FIG. 13 is a block diagram showing a configuration of a main part of a store-by-store merchandise server in the embodiment;

FIG. 14 shows a merchandise list stored in a merchandise management area of the store-by-store merchandise server in the embodiment;

FIG. 15 shows a payment store list stored in a payment store management area of the store-by-store merchandise server in the embodiment;

FIG. 16 shows a purchase information list stored in a purchase information area of the store-by-store merchandise server in the embodiment;

FIG. 17 shows a data structure of a record stored in a data structure of a record stored in a purchase information management area of the store-by-store merchandise server in the embodiment;

FIG. 18 is a block diagram showing a configuration of a main part of an affiliated relationship management server in the embodiment;

FIG. 19 shows an affiliated store list stored in an affiliated relationship management area of the affiliated relationship management server in the embodiment;

FIG. 20 shows a data structure of a command for updating an affiliated relationship list of the affiliated relationship management server in the embodiment;

FIG. 21 is a schematic diagram showing a state on a seller store side in the shopping system of the embodiment;

FIG. 22 is a flowchart showing a processing procedure performed by CPU of the mobile terminal in ordering merchandise purchase in the embodiment;

FIG. 23 is a flowchart specifically showing a processing procedure in a first half of step of “shopping processing” in FIG. 22 in the embodiment;

FIG. 24 is a flowchart specifically showing a processing procedure after a shopping command of step of “shopping processing” in FIG. 22 is transmitted in the embodiment;

FIG. 25 is a flowchart specifically showing a processing procedure after a “Delete” button of step of “shopping processing” in FIG. 22 is input in the embodiment;

FIG. 26 is a flowchart specifically showing a processing procedure after an “End” button of step of “shopping processing” in FIG. 22 is input in the embodiment;

FIG. 27 is a flowchart showing a processing procedure performed by CPU of the store management server in receiving a request command in the embodiment;

FIG. 28 is a flowchart showing a processing procedure performed by CPU of the store-by-store merchandise server in receiving an inquiry command in the embodiment;

FIG. 29 is a flowchart specifically showing a processing procedure after step of “shopping command reception” in FIG. 28 in the embodiment;

FIG. 30 is a flowchart specifically showing a processing procedure after step of “delete command reception” in FIG. 28 in the embodiment;

FIG. 31 is a flowchart specifically showing a processing procedure after step of “abort command reception” in FIG. 28 in the embodiment;

FIG. 32 is a flowchart specifically showing a processing procedure after step of “closing command reception” in FIG. 28 in the embodiment;

FIG. 33 is a flowchart showing a processing procedure performed by CPU of the payment terminal in receiving payment from the mobile terminal in the embodiment;

FIG. 34 is a flowchart specifically showing a processing procedure of step of “outstanding transaction information processing” in FIG. 33 in the embodiment;

FIG. 35 is a flowchart specifically showing a processing procedure of step of “payable transaction information processing” in FIG. 33 in the embodiment;

FIG. 36 is a flowchart specifically showing a processing procedure of step of “information-by-information electronic payment processing” in FIG. 33 in the embodiment;

FIG. 37 is a flowchart showing a processing procedure performed by CPU of the mobile terminal in payment for the merchandise in the embodiment;

FIG. 38 is a flowchart showing a processing procedure performed by CPU of the store-by-store merchandise server in receiving a command sent from the payment terminal in the embodiment;

FIG. 39 is a flowchart showing a processing procedure performed by CPU of the store terminal in receiving a payment completion notification command in the embodiment;

FIG. 40 is a flowchart showing a procedure of payment store request processing periodically performed by CPU of the store-by-store merchandise server in the embodiment;

FIG. 41 is a flowchart showing a procedure of affiliated store request processing periodically performed by CPU of the payment terminal in the embodiment;

FIG. 42 is a flowchart showing a processing procedure performed by CPU of the affiliated store management server in receiving a main command in the embodiment;

FIG. 43 shows an example of a purchase confirmation screen displayed on a display unit of the mobile terminal in the embodiment;

FIG. 44 shows an example of a payment store list screen displayed on the display unit of the mobile terminal in the embodiment;

FIG. 45 shows an example of a guide map screen from a sales store to a payment store displayed on the display unit of the mobile terminal in the embodiment; and

FIG. 46 shows an example of a purchase order confirmation screen displayed on the store terminal in the embodiment.

### DETAILED DESCRIPTION OF THE INVENTION

A best mode for carrying out the invention will be described below with reference to the drawings. First a configuration of a shopping system of the embodiment will be described.

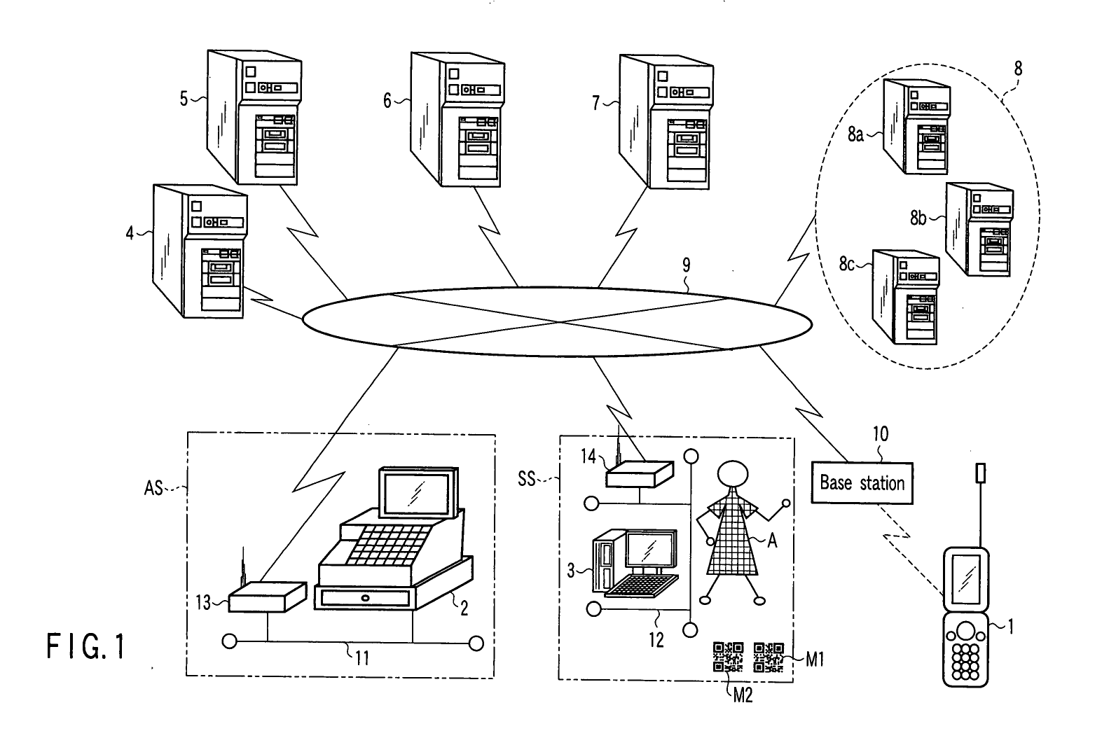

FIG. 1 is a schematic diagram of the shopping system. The shopping system includes a mobile terminal 1, a payment terminal 2, a store terminal 3, and plural servers 4 to 8. For example, the mobile terminal 1 is a camera-equipped cellular phone. For example, the payment terminal 2 is a point-of-sales (POS) terminal. For example, the store terminal 3 is a personal computer.

A consumer uses the mobile terminal 1. The payment terminal 2 is installed in a payment store AS. The store terminal 3 is installed in a sales store SS. The servers 4 to 8 are installed in a management company which realizes a shopping method of the shopping system.

The sales store SS sells merchandise item A displayed in a store window outside opening hours. In place of the sales store SS, the payment store AS receives payment request for merchandise item A sold in the sales store SS outside opening hours. For example, around-the-clock stores such as a convenience store are suitable to the sales store SS. An affiliated relationship for representation payment is previously established between the sales store SS and the payment store AS. The consumer purchases merchandise in the sales store SS by using the mobile terminal 1, and pays for the merchandise in payment store SS.

The payment terminal 2, the store terminal 3, and the plural servers 4 to 8 are connected to one another through a network 9 such as the Internet. The mobile terminal 1 is connected the network through a base station 10. The payment terminal 2 and the store terminal 3 are connected to the network 9 through an intra-store local area network (LAN) 11 and 12 and routers 13 and 14.

In the store window of the sales store SS, symbols M1 and M2 of a two-dimensional data code pasted to a site which can be confirmed from outside the store. The symbol M1 is a two-dimensional data code including a store identification code for identifying the store. The symbol M2 is a two-dimensional data code including a merchandise identification code for identifying merchandise item A displayed in the store window. The symbols M1 and M2 can be scanned by a camera function of the mobile terminal 1.

A server group includes a program delivery server 4, an affiliated relationship management server 5, a user management server 6, a store management server 7, and a store-by store merchandise server 8 (8a, 8b, 8c, . . . ).

The program delivery server 4 is specialized in delivering a program necessary to construct the shopping system to the mobile terminal 1 carried by the consumer. The affiliated relationship management server 5 is specialized in managing an affiliated relationship between the sales store SS and the payment store AS. The user management server 6 is specialized in managing information on the consumer registered as a user. The store management server 7 is specialized in managing information on the sales store SS and payment store AS. The merchandise server 8 is specialized in management of information on each item of merchandise sold in the sales store SS and management concerning sales of the merchandise. The merchandise server 8 is provided in each sales store SS.

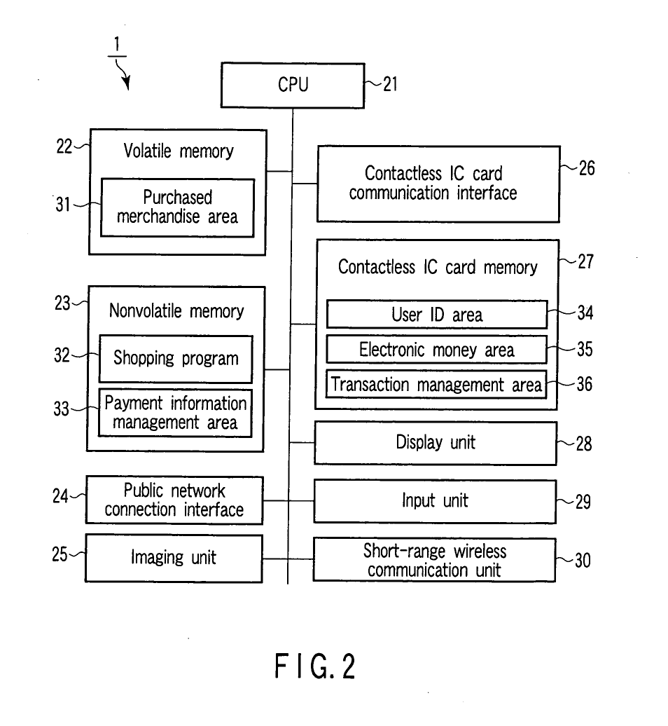

FIG. 2 is a block diagram showing a configuration of a main part of the mobile terminal 1. The mobile terminal 1 includes a CPU 21, a volatile memory 22, a nonvolatile memory 23, a public network connection interface 24, an imaging unit 25, a contactless IC card interface 26, a contactless IC card memory 27, a display unit 28, an input unit 29, and a short-range wireless communication unit 30.

The mobile terminal 1 is connected to the network 9 through the public network connection interface 24. The mobile terminal 1 transmits data already recorded in the contactless IC card memory 27 and receives data to be recorded in the contactless IC card memory 27 through the contactless IC card interface 26.

A purchased merchandise area 31 is formed in the volatile memory 22. A program area 32 and a payment information management area 33 are formed in the nonvolatile memory 23. The shopping program delivered from the program delivery server 4 is stored in the program area 32. The shopping program causes the mobile terminal 1 to function as a shopping instrument.

A user ID area 34, an electronic money area 35, and a transaction management area 36 are formed in the contactless IC card memory 27. User ID, which is a user identification code, is stored in the user ID area 34. Each consumer, who is a user of the mobile terminal 1, is identified by the user ID. Balance data of electronic money is stored in the electronic money area 35.

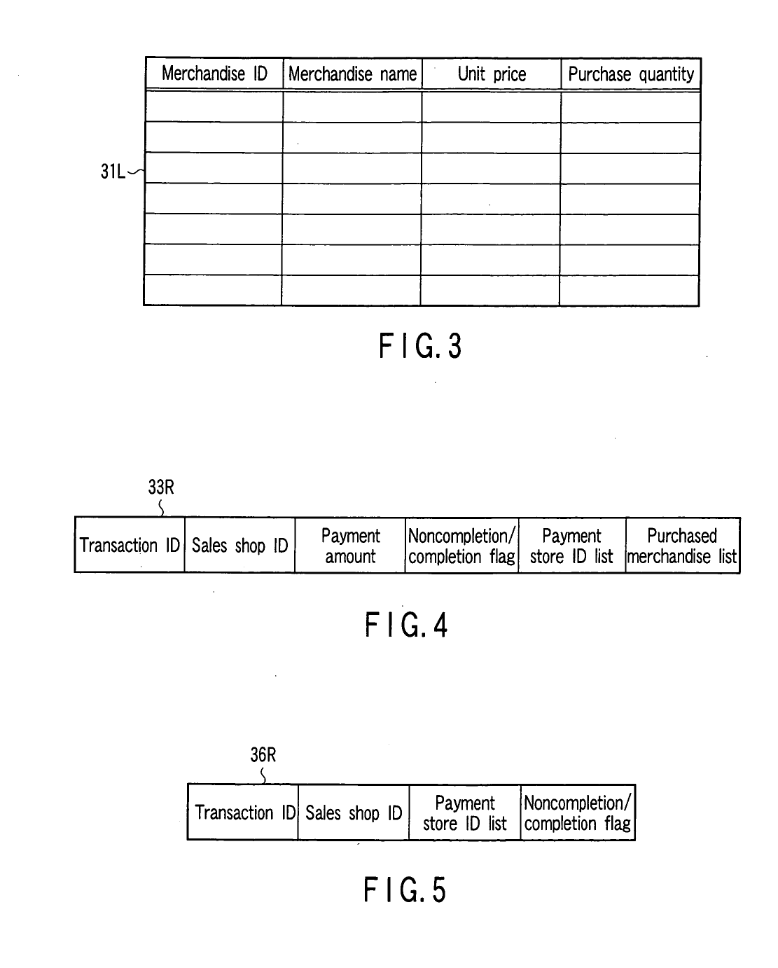

A purchased merchandise list 31L is stored in the purchased merchandise area 31. As shown in FIG. 3, the list 31L includes items such as merchandise ID, a merchandise name, a unit price, and purchase quantity. The items corresponding to the merchandise purchased using the mobile terminal 1 are written in the purchased merchandise list 31L.

A payment information management record 33R is stored in the payment information management area 33. As shown in FIG. 4, the payment information management record 33R includes pieces of data such as transaction ID, sales store ID, a payment amount, a noncompletion/completion flag, a payment store ID list, and a purchased merchandise list.

A transaction management record 36R is stored in the transaction management area 36. As shown in FIG. 5, the transaction management record 36R includes pieces of data such as the transaction ID, the sales store ID, the payment store ID list, and the noncompletion/completion flag.

The merchandise ID is a code for identifying each item of merchandise sold in the sales store SS. The transaction ID is a code for identifying each commercial transaction of the representation payment with the mobile terminal 1. The sales store ID is a code for identifying each sales store SS. The payment store ID is a code for identifying each payment store AS. The data of the payment store ID list includes the pieces of store ID of all the payment stores AS making a contract of the representation payment with the sales store SS identified by the sales store ID. The noncompletion/completion flag is bit data for determining whether or not the payment for the commercial transaction identified by the transaction ID is completed.

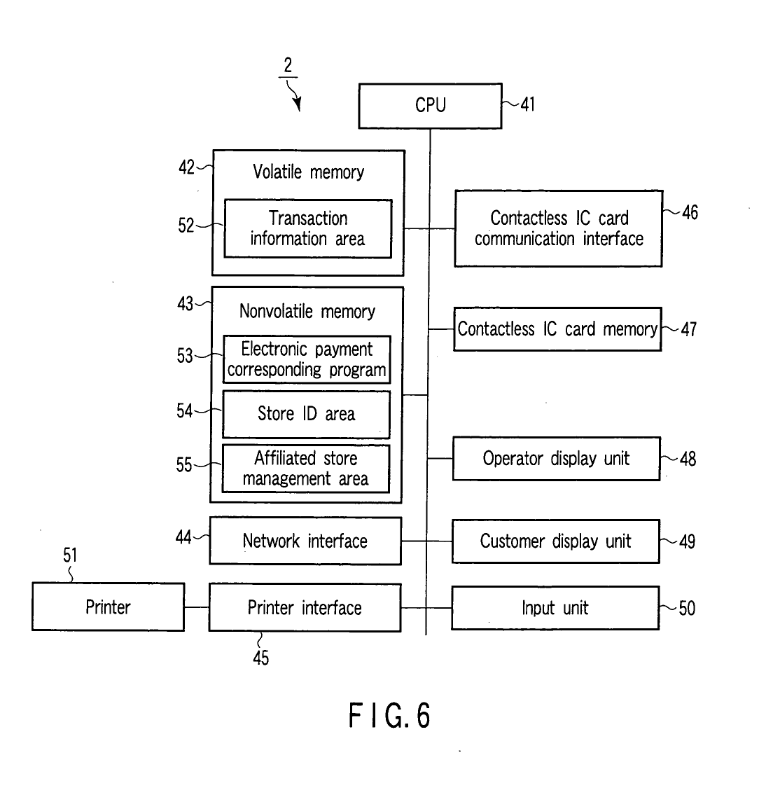

FIG. 6 is a block diagram showing a configuration of a main part of the payment terminal 2. The payment terminal 2 includes a CPU 41, a volatile memory 42, a nonvolatile memory 43, a network interface 44, a printer interface 45, a contactless IC card interface 46, a contactless IC card memory 47, an operator display unit 48, a customer display unit 49, and an input unit 50. A printer 51 is connected to the printer interface 46 to print a receipt.

The payment terminal 2 is connected to the network 9 through the network interface 44. The payment terminal 2 transmits data already recorded in the contactless IC card memory 47 and receives data to be recorded in the contactless IC card memory 47 through the contactless IC card interface 46.

A transaction information area 52 is formed in the volatile memory 42. A program area 53, a store ID area 54, and an affiliated store management area 55 are formed in the nonvolatile memory 43.

An electronic payment corresponding program is stored in the program area 53. The store ID of the payment store AS in which the payment terminal 2 is installed is stored in the store ID area 54.

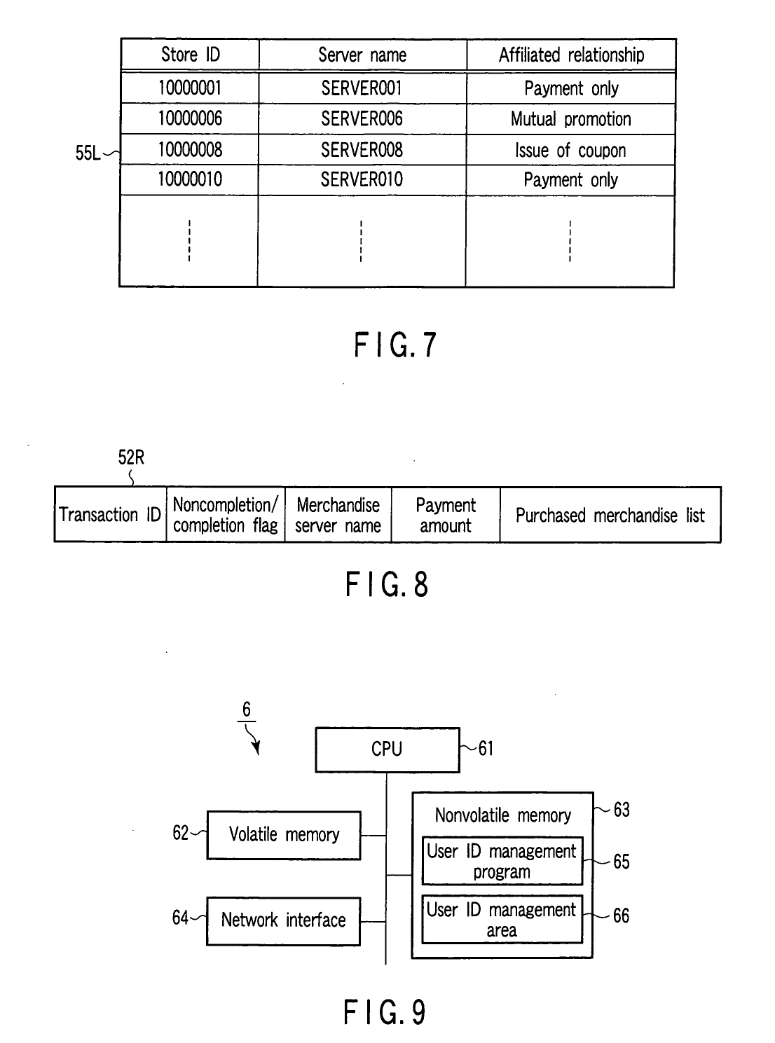

An affiliated store list 55L is stored in the affiliated store management area 55. As shown in FIG. 7, the list 55L includes items such as the store ID, a server name, and an affiliated relationship. The pieces of store ID of all the sales stores SS whose representation payment can be performed in the store of the payment terminal 2, the server name of the merchandise server 8 for the sales store SS, and the data indicating the affiliated relationship between the sales store SS and the store of the payment terminal 2 are written in the affiliated store list 55L.

A transaction information record 52R is stored in the transaction information area 52. As shown in FIG. 8, the transaction information record 52R includes pieces of data such as the transaction ID, the noncompletion/completion flag, a merchandise server name, the payment amount, and the purchased merchandise list.

FIG. 9 is a block diagram showing a configuration of a main part of the user management server 6. The user management server 6 includes a CPU 61, a volatile memory 62, a nonvolatile memory 63, and a network interface 64. The user management server 6 is connected to the network 9 through the network interface 64.

A program area 65 and a user ID management area 66 are formed in the nonvolatile memory 63. A user ID management program is stored in the program area 65.

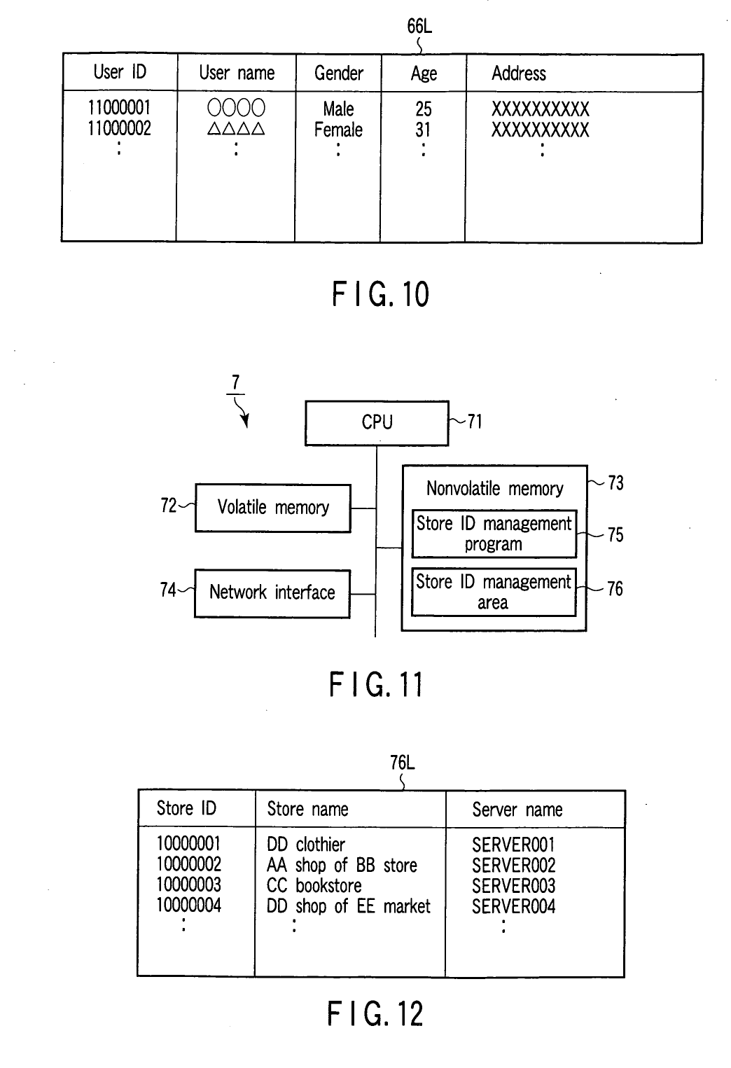

A user list 66L is stored in the user ID management area 66. As shown in FIG. 10, the list 66L includes items such as the user ID, the user name, gender, age, and an address. The items corresponding to each consumer who is registered as the user are written in the user list 66L.

FIG. 11 is a block diagram showing a configuration of a main part of a store management server 7. The store management server 7 includes a CPU 71, a volatile memory 72, a nonvolatile memory 73, and a network interface 74. The store management server 7 is connected to the network 9 through the network interface 74.

A program area 75 and a store ID management area 76 are formed in the nonvolatile memory 73. A store ID management program is stored in the program area 75.

A store list 76L is stored in the store ID management area 76. As shown in FIG. 12, the list 76L includes items such as the store ID, the store name, and the server name. The pieces of store ID of all the sales stores SS joining in the shopping system and the server name of the merchandise server for the sales store SS are written in the store list 76L.

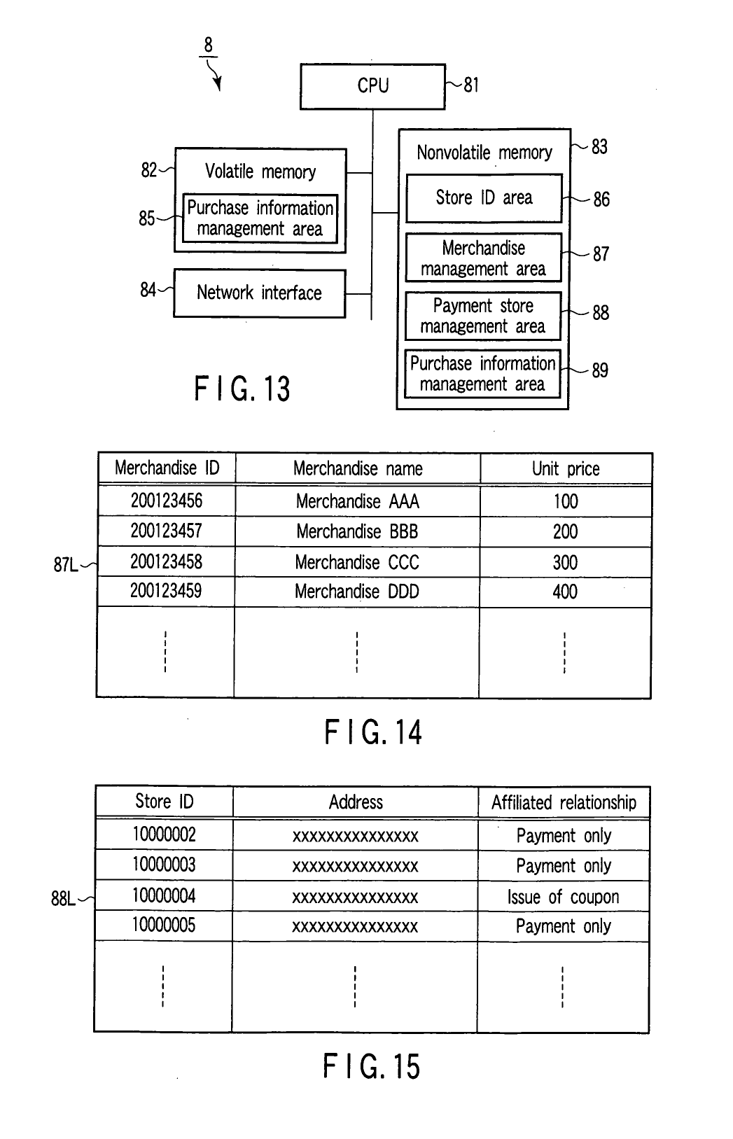

FIG. 13 is a block diagram showing a configuration of a main part of the merchandise server 8 (8a, 8b, 8c, . . . ). Each merchandise server 8 includes a CPU 81, a volatile memory 82, a nonvolatile memory 83, and a network interface 84. Each merchandise server 8 is connected to the network 9 through the network interface 84.

A purchase information management area 85 is formed in the volatile memory 82.

A store ID area 86, a merchandise management area 87, a payment store list 88L, and a purchase information management area 89 are formed in the nonvolatile memory 83. The store ID of the sales store SS to which the merchandise server 8 corresponds is stored in the store ID area 86.

A merchandise list 87L is stored in the merchandise management area 87. As shown in FIG. 14, the list 87L includes items such as the merchandise ID, the merchandise name, and the unit price. The items corresponding to the merchandise sold in the sales store SS to which the merchandise server 8 corresponds are written in the merchandise list 87L.

A payment store list 88L is stored in the payment store management area 88. As shown in FIG. 15, the list 88L includes items such as the store ID, the address, and the affiliated relationship. The items corresponding to each payment store AS which makes the contract of the representation payment with the sales store SS to which the merchandise server 8 corresponds are written in the payment store list 88L.

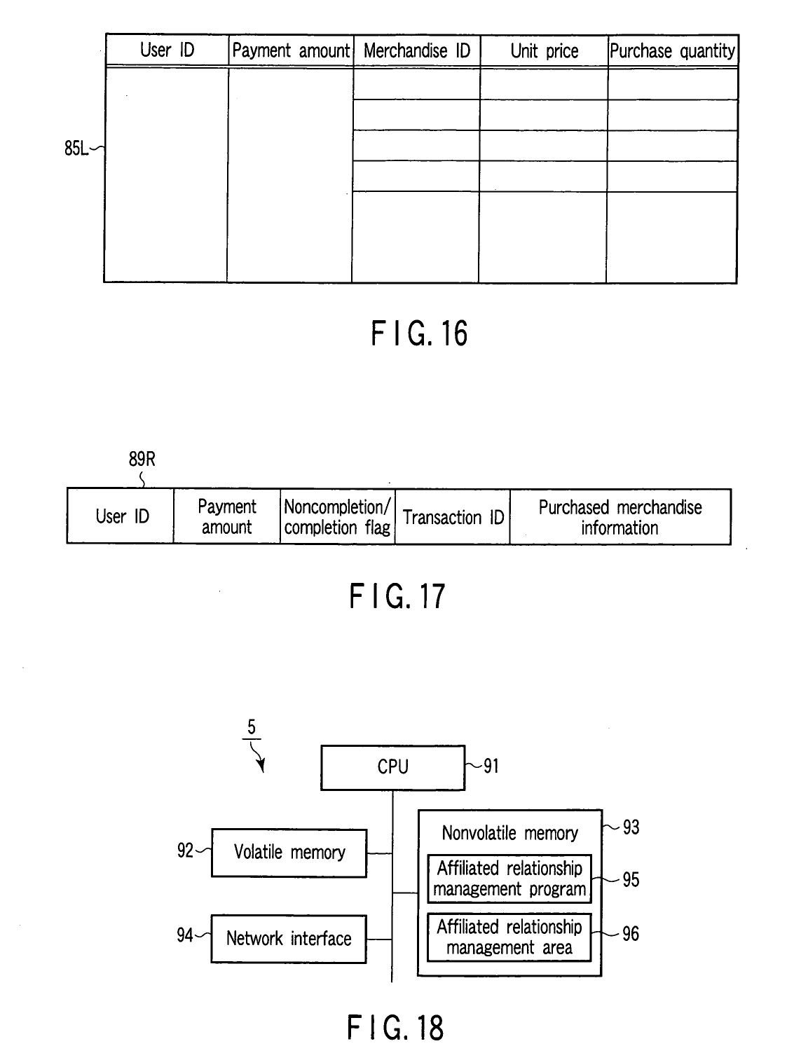

A purchase information list 85L is stored in the purchase information management area 85. As shown in FIG. 16, the list 85L includes items such as the user ID, the payment amount, the merchandise ID, the unit price, and the purchase quantity. The user ID of the consumer who purchases the merchandise in the sales store SS to which the merchandise server 8 corresponds using the mobile terminal 1 and the merchandise ID, unit price, purchase quantity, and payment amount of the purchased merchandise are written in the purchase information list 85L.

A purchase information record 89R is stored in the purchase information management area 89. As shown in FIG. 17, the purchase information record 89R includes pieces of data such as the user ID, the payment amount, the noncompletion/completion flag, the transaction ID, and the purchased merchandise information.

FIG. 18 is a block diagram showing a configuration of a main part of an affiliated relationship management server 5. The affiliated relationship management server 5 includes a CPU 91, a volatile memory 92, a nonvolatile memory 93, and a network interface 94. The affiliated relationship management server 5 is connected to the network 9 through the network interface 94.

A program area 95 and an affiliated relationship management area 96 are formed in the nonvolatile memory 93. An affiliated relationship management program is stored in the program area 95.

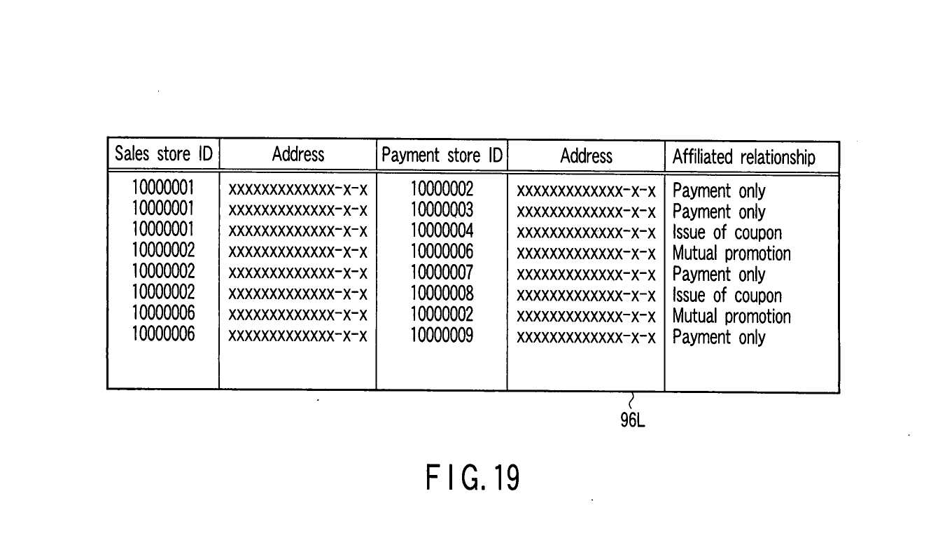

An affiliated relationship list 96L is stored in the affiliated relationship management area 96. As shown in FIG. 19, the list 96L includes items such as the sales store ID, an address, the payment store ID, an address, and the affiliated relationship. Each ID and address of one sales store SS, the ID and address of one payment store AS having the affiliated relationship with the sales store SS, and data indicating each affiliated relationship are written in the affiliated relationship list 96L. Examples of the affiliated relationship include payment only, issue of coupon, and mutual promotion.

In the case where the affiliated relationship between the sales store SS and the payment store AS is changed, the affiliated relationship list 96L is updated. The data update processing is executed as follows by the affiliated relationship management program.

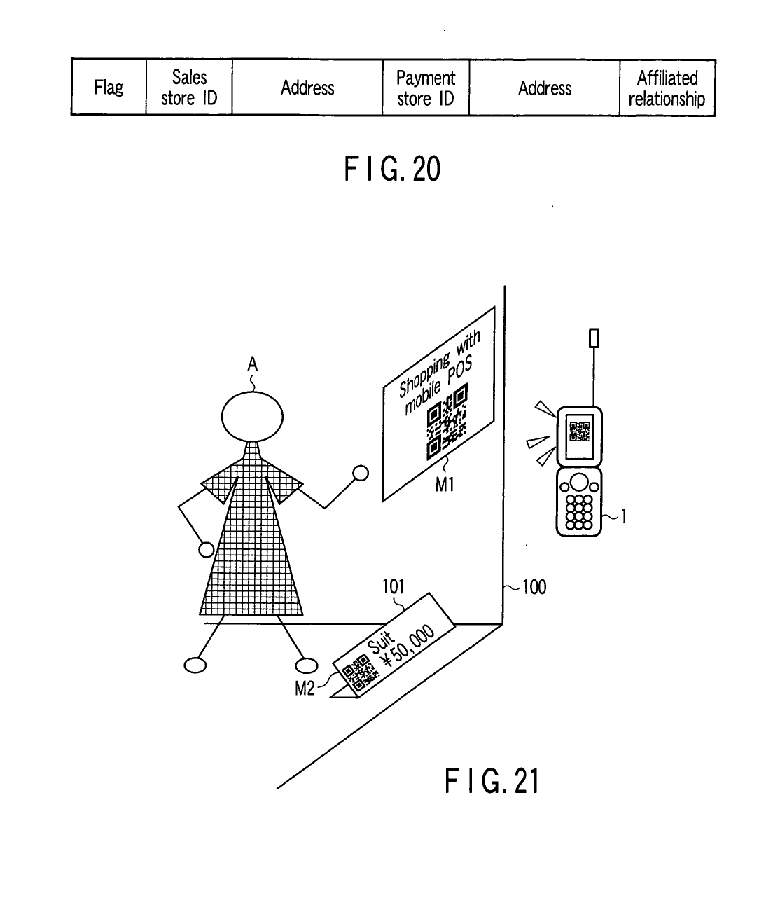

An update command of the affiliated relationship list 96L is input to the affiliated relationship management server 5 from an input terminal such as a personal computer. As shown in FIG. 20, the update command includes an attribute flag, the ID and address of the sales store SS, the ID and address of the payment store AS, and the affiliated relationship. The attribute flag is used to distinguish data added to the affiliated relationship list 96L from data deleted from the list 96L.

When receiving the update command, the CPU 91 of the affiliated relationship management server 5 recognizes the attribute flag of the update command.

When the update command is an instruction to add the data to the list 96L, the pieces of data except for the attribute flag are added to the affiliated relationship list 96L. When the update command is an instruction to delete the data from the list 96L, the corresponding pieces of data except for the attribute flag are deleted from the affiliated relationship list 96L.

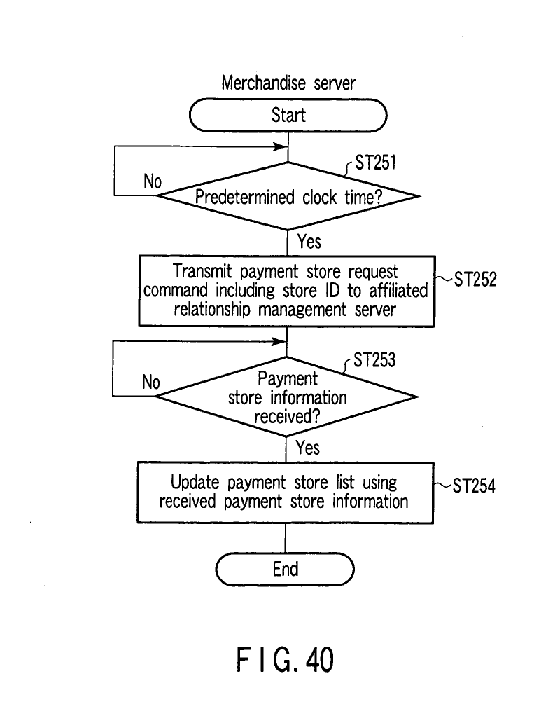

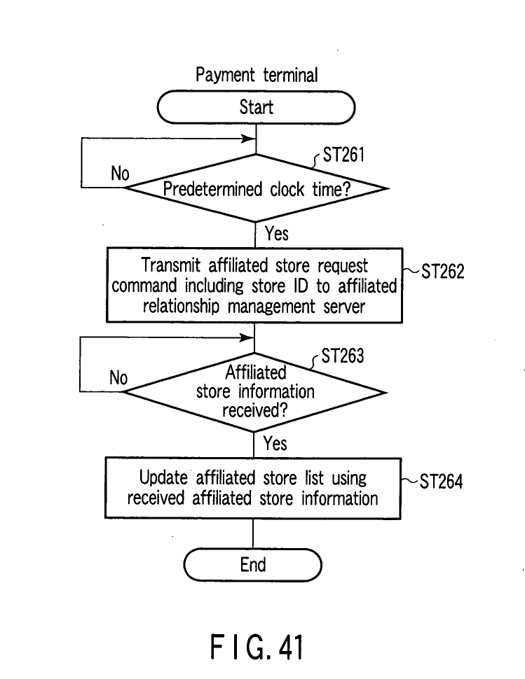

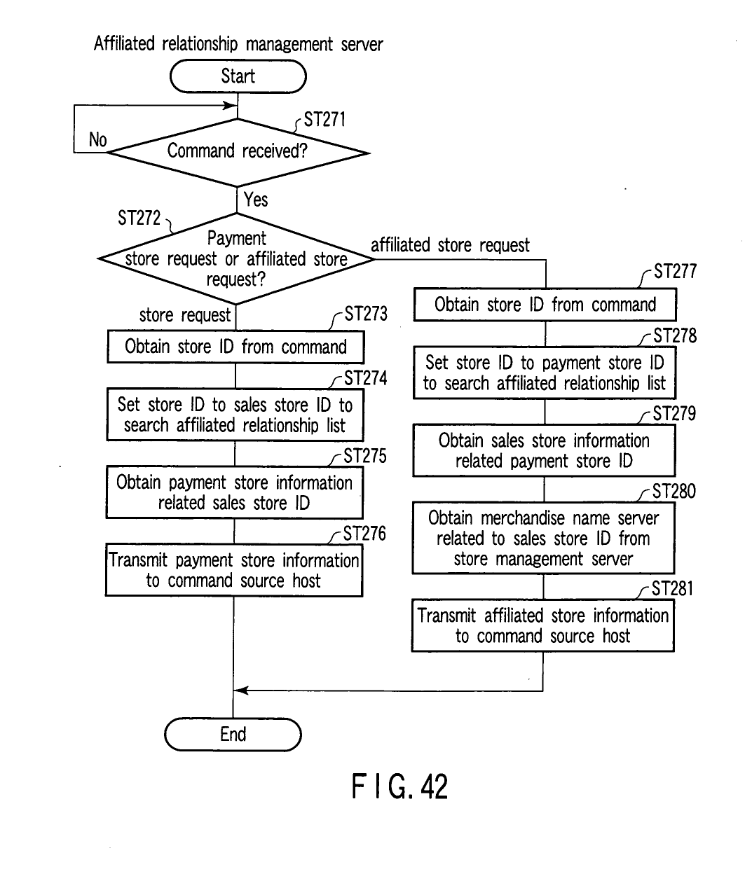

The payment store list 88L of the merchandise server 8 and the affiliated store list 55L of the payment terminal 2 are also updated when the affiliated relationship list 96L is updated. The procedure is described by the flowcharts of FIGS. 40 to 42. FIG. 40 shows a procedure of the merchandise server 8, FIG. 41 shows a procedure of the payment terminal 2, and FIG. 42 shows a procedure of the affiliated store management server 5.

The CPU 81 of the merchandise server 8 waits for a predetermined clock time every day (step ST251). When the predetermined clock time comes (YES in step ST251), the CPU 81 transmits a payment store request command to the affiliated relationship management server 5 through the network 9 (step ST252). The payment store request command includes the store ID in the store ID area 86.

The CPU 91 of the affiliated relationship management server 5 is in the standby state to receive a command (step ST271). When receiving the command (YES in step ST271), the CPU 91 determines the type of the command (step ST272). When the command is the payment store request command, the CPU 91 obtains the store ID from the payment store request command (step ST273).

After this, the CPU 91 searches the affiliated relationship list 96L while the store ID obtained from the payment store request command is assumed to be the sales store ID (step ST274). The CPU 91 extracts the payment store ID, the address corresponding to the payment store ID, and the affiliated relationship from all the pieces of data including the sales store ID (step ST275). The CPU 91 transmits the extracted pieces of data which are the payment store information through the network 9 to the merchandise server 8 which is the source host (step ST276).

After transmitting the payment store request command, the CPU 81 of the merchandise server 8 is in the standby state to receive the payment store information (step ST253). When the CPU 81 receives the payment store information from the affiliated relationship management server 5 through the network 9 (YES in step ST253), the CPU 81 rewrites the payment store list 88L with the received payment store information (step ST254). Thus, the payment store list 88L is updated to the latest state.

The CPU 41 of the payment terminal 2 also waits for a predetermined clock time every day (step ST261). When the predetermined clock time arrives (YES in step ST261), the CPU 41 transmits an affiliated store request command to the affiliated relationship management server 5 through the network 9 (step ST262). The affiliated store request command includes the store ID in the store ID area 54.

The CPU 91 of the affiliated relationship management server 5 is in the standby state to receive a command (step ST271). When receiving the command (YES in step ST271), the CPU 91 determines the type of the command (step ST272). When the command is the affiliated store request command, the CPU 91 obtains the store ID from the affiliated store request command (step ST277).

After this, the CPU 91 searches the affiliated relationship list 96L while the store ID obtained from the affiliated store request command is assumed to be the payment store ID (step ST278). The CPU 91 extracts the sales store ID from all the pieces of data including the payment store ID (step ST279). The CPU 91 accesses the store management server 7 using the store ID, and the CPU 91 obtains the server name corresponding to the store ID from the store list 76L of the store management server 7 (step ST280).

After this, the CPU 91 sets the sales store ID and affiliated relationship, read from the affiliated relationship list 96L, and the server name obtained from the store management server 7 to the affiliated store information. The CPU 91 transmits the affiliated store information through the network 9 to the payment terminal 2 which is the source host (step ST281).

After transmitting the affiliated store request command, the CPU 41 of the payment terminal 2 is in the standby state to receive the affiliated store information (step ST263). When the CPU 41 receives the affiliated store information from the affiliated relationship management server 5 through the network 9 (YES in step ST263), the CPU 41 rewrites the affiliated store list 55L with the received affiliated store information (step ST264). Thus, the affiliated store list 55L is updated to the latest state.

A selling method and a payment method of the shopping system will be described.

As shown in FIG. 21, in the sales store SS, merchandise item A is displayed in a store window 100 which is a merchandise display unit, which enables merchandise item A to be browsed from outside the sales store SS outside opening hours. The two-dimensional data code symbol M2 including the merchandise ID of merchandise item A is printed in a price tag plate 101 of merchandise item A. A label 102, in which the two-dimensional data code symbol M1 including the store ID of the sales store SS is printed, is pasted to the store window 100.

The consumer can purchase merchandise item A displayed in the store window 100 using the mobile terminal 1 even in the time during which the sales store SS is closed. However, it is necessary that the consumer previously operate the mobile terminal 1 to access a WEB site of the service company in order to perform the user registration. At this point, the consumer inputs items such as name, sex, age, and address. The consumer performs the user registration once only.

When the user registration is performed, the mobile terminal 1 transmits a shopping program download request command to the program delivery server 4. The shopping program download request command includes user information registered by the respective consumers.

When receiving the shopping program download request command, the program delivery server 4 obtains the user information from the shopping program download request command. The program delivery server 4 generates a user ID issue request command including the user information and transmits the user ID issue request command to the user management server 6.

When receiving the user ID issue request command, the user management server 6 obtains the user information from the user ID issue request command. The user management server 6 examines carefully the user information according to the user ID management program. In the case of no problem with the user information as a result of the careful examination, the user management server 6 generates a new unique user ID. The user management server 6 adds the user information to the user list 66L while relating the user information to the user ID. The user management server 6 transmits the user ID to the program delivery server 4.

When receiving the user ID, the program delivery server 4 downloads the user ID and the shopping program to the mobile terminal 1 through the network 9. The shopping program is stored in the program area 32 of the mobile terminal 1. The user ID is stored in the user ID area 34 of the contactless IC card memory 27.

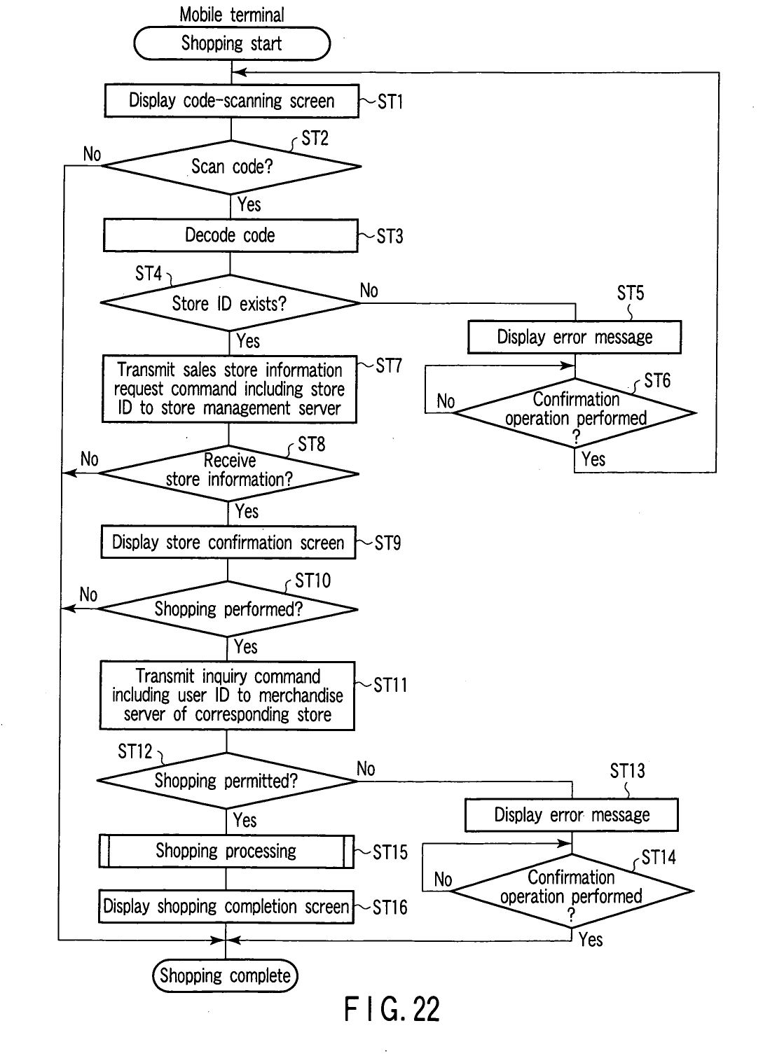

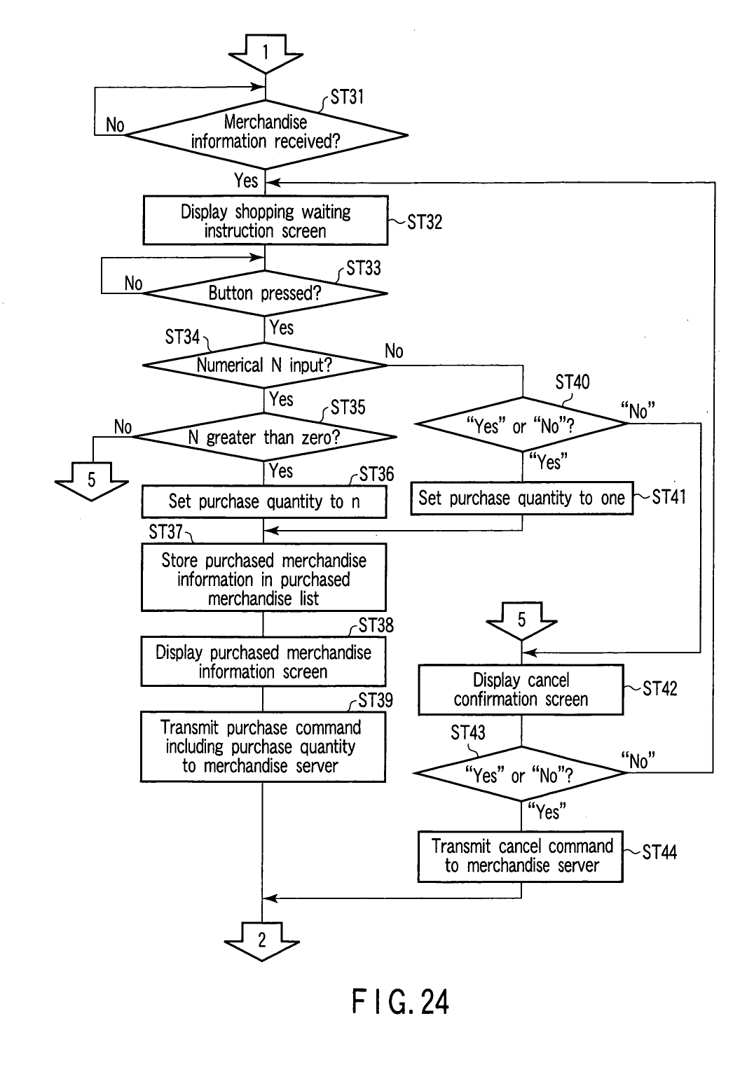

When the consumer whose user registration is already performed wants to purchase merchandise item A in the store window 100, the consumer operates the mobile terminal 1 to start up the shopping program. This enables pieces of processing in flowcharts of FIGS. 22 to 26 to be performed in the mobile terminal 1.

That is, in step ST1, the CPU 21 of the mobile terminal 1 operates the imaging unit 25 to display a code-scanning screen on the display unit 28. In the mobile terminal 1, the two-dimensional data code or barcode can be scanned from the code-scanning screen. In step ST2, the CPU 21 is in the standby state in which the code is scanned. When the code is not scanned within a predetermined time, the shopping program is ended.

When the code is scanned through the imaging unit 25 (YES in step ST2), the CPU 21 decodes the code in step ST3. In step ST4, the CPU 21 determines whether or not the code includes the store ID.

When the code does not include the store ID (NO in step ST4), the scanned code is not the two-dimensional data code symbol M1. In this case, for example, the CPU 21 causes the display unit 28 to display an error message of “scan a code symbol of store ID” in step ST5. After this, when confirmation operation is performed in step ST6, the flow returns to step ST1 to display the code-scanning screen again.

When the codes include the store ID (YES in step ST4), the scanned code is the two-dimensional data code symbol M1. In this case, the CPU 21 transmits a sales store information request command to the store management server 7 through the network 9 in step ST7. The sales store information request command includes the store ID decoded from the scanned code.

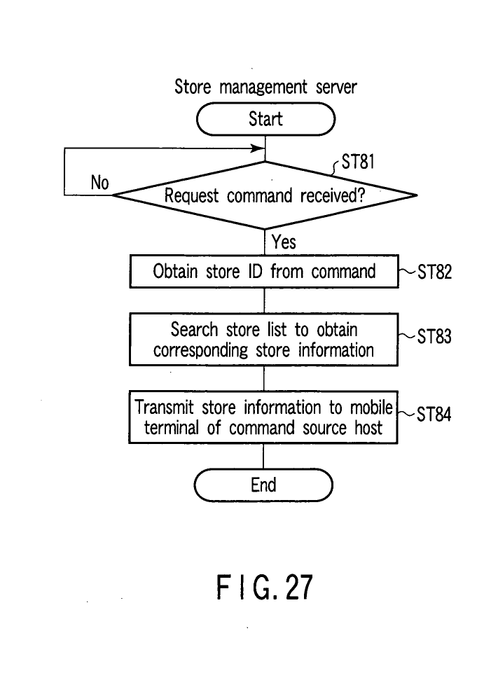

The store management server 7 performs processing shown in a flowchart of FIG. 27. In step ST81, the CPU 71 of the store management server 7 is in the standby state to wait for the sales store information request command. When receiving the sales store information request command sent from the mobile terminal 1 (YES in step ST81), the CPU 71 obtains the store ID from the sales store information request command in step ST82. In step ST83, the CPU 71 searches the store list 76L using the store ID, and the CPU 71 obtains the store information on the store ID, i.e., the store name and the server name. After this, in step ST84, the CPU 71 transmits the store information to the mobile terminal 1 which is the source host.

In step ST8, the CPU 21 of the mobile terminal 1 transmitting the sales store information request command is in the standby state to wait for the store information. When receiving the store information from the store management server 7 (YES in step ST8), the CPU 21 causes the display unit 28 to display a store confirmation screen in step ST9. The store name in the received store information and guidance for selecting whether or not the shopping is performed in the store are displayed in the store confirmation screen. After this, the CPU 21 accepts the selection whether or not the shopping is performed (step ST10).

The consumer operates the input unit 29 to select whether or not the shopping is performed. When the consumer selects that the shopping is not performed (NO in step ST10), the shopping program is ended.

When the consumer selects that the shopping is performed (YES in step ST10), the CPU 21 transmits an inquiry command through the network 9 to the merchandise server 8 which is identified by the server name in the store information received in step ST11. The inquiry command includes the user ID of the user ID area 34.

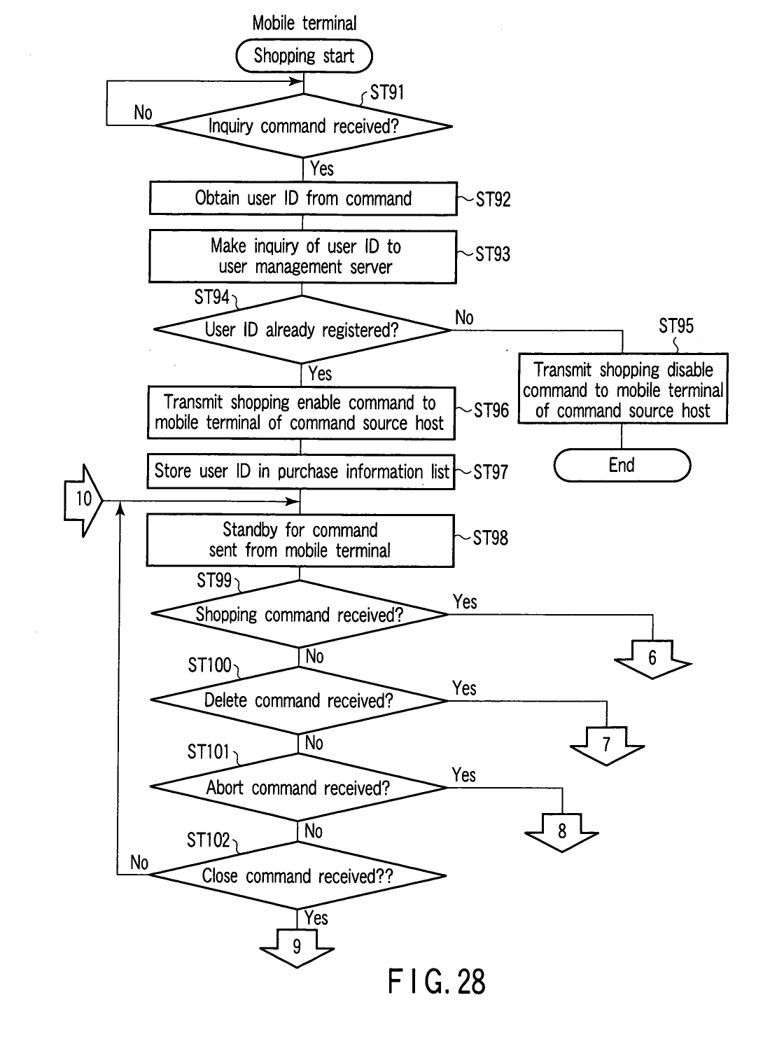

The merchandise server 8 performs processing shown in a flowchart of FIG. 28. That is, the CPU 81 of the merchandise server 8 is in the standby state to wait for the inquiry command in step ST91. When receiving the inquiry command sent from the mobile terminal 1, the CPU 81 obtains the user ID from the inquiry command in step ST92. In step ST93, the CPU 81 makes an inquiry whether or not the user ID is registered to the user management server 6.

When the user management server 6 sends back a response that the user ID is not registered (NO in step ST94), the CPU 81 produces a shopping disable command in step ST95. The CPU 81 transmits the shopping disable command to the mobile terminal 1 which is the source host of the inquiry command.

When the user management server 6 sends back a response that the user ID is registered (YES in step ST94), the CPU 81 produces a shopping enable command in step ST96. The CPU 81 transmits the shopping enable command to the mobile terminal 1 which is the source host of the inquiry command. In step ST97, the CPU 81 stores the user ID in the purchase information list 85L. In ST 98, the CPU 81 is in the standby state to wait for the next command sent from the mobile terminal 1.

After transmitting the inquiry command, the CPU 21 of the mobile terminal 1 is in the standby state to wait for a response command sent from the merchandise server 8 in step ST12. When receiving the shopping disable command (NO in step ST12), the CPU 21 causes the display unit 28 to display an error message of shopping disable in step ST13. At this point, when the confirmation operation is performed in step ST14, the shopping program is ended.

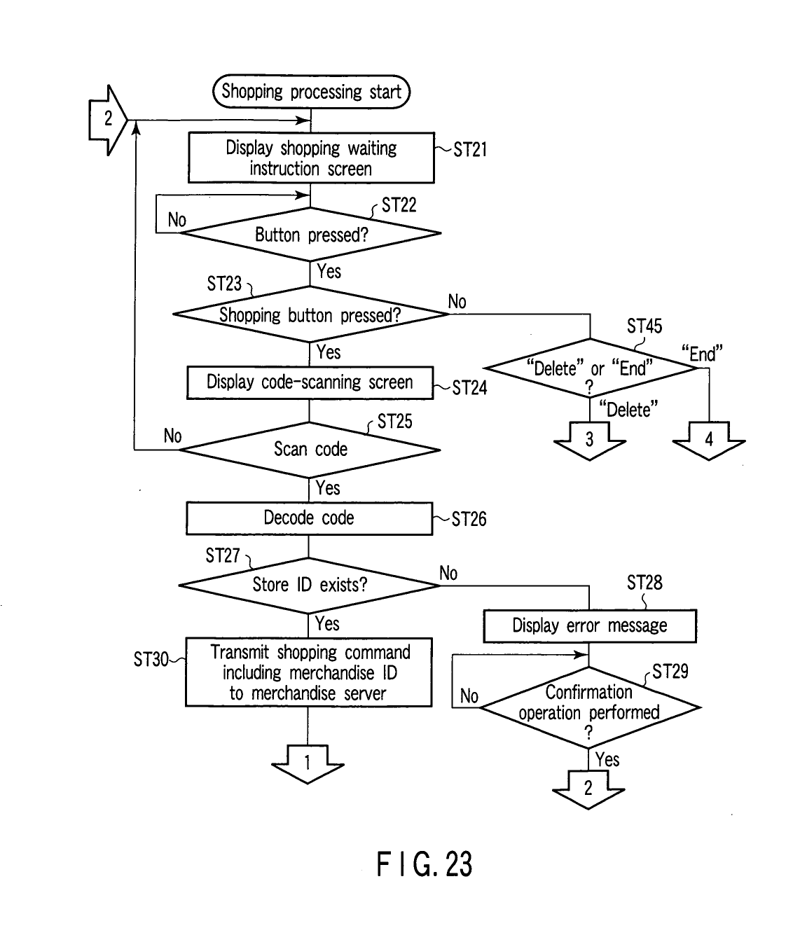

On the other hand, when receiving the shopping enable command (YES in step ST12), the CPU 21 performs shopping processing specifically shown in flowcharts of FIGS. 23 to 26 in step ST15.

In step ST21, CPU 11 causes the display unit 28 to display a shopping waiting instruction screen. In the guidance displayed on the shopping waiting instruction screen, a “Shopping” button is input when the shopping is performed, a “Delete” button is input when the purchased merchandise is canceled, and an “End” button is input when the shopping is ended. In the case where the data is stored in the purchased merchandise list 31L, at least the merchandise names in the data are listed on the shopping waiting instruction screen.

The consumer presses any one of the buttons according to the guidance. In step ST22, the CPU 21 is in the standby state to wait for the pressing of any one of the buttons. When the “Shopping” button is input (YES in step ST23), the CPU 21 again operates the imaging unit 25 to cause the display unit 28 to display the code-scanning screen in step ST24. In step ST25, the CPU 21 is in the standby state in which the code is scanned. At this point, when the code is not scanned within the predetermined time (NO in step ST25), CPU 21 returns the screen of the display unit 28 to the shopping waiting instruction screen (step ST21).

When the code is scanned through the imaging unit 25 (YES in step ST25), the CPU 21 decodes the code in step ST26. In step ST27, the CPU 21 determines whether or not the code includes the merchandise ID.

When the code does not include the merchandise ID (NO in step ST27), the scanned code is not the two-dimensional data code symbol M2. At this point, in step ST28, the CPU 21 causes the display unit 28 to display the error message “Scan code symbol of merchandise ID”. In step ST29, when the confirmation operation is performed, the CPU 21 returns the screen of the display unit 28 to the shopping waiting instruction screen (step ST21).

When the decoded code includes the merchandise ID (YES in step ST27), the scanned code is the two-dimensional data code symbol M2. At this point, the CPU 21 transmits a shopping command to the merchandise server 8 through the network 9 in step ST30. The shopping command includes the merchandise ID decoded from the two-dimensional data code symbol M2.

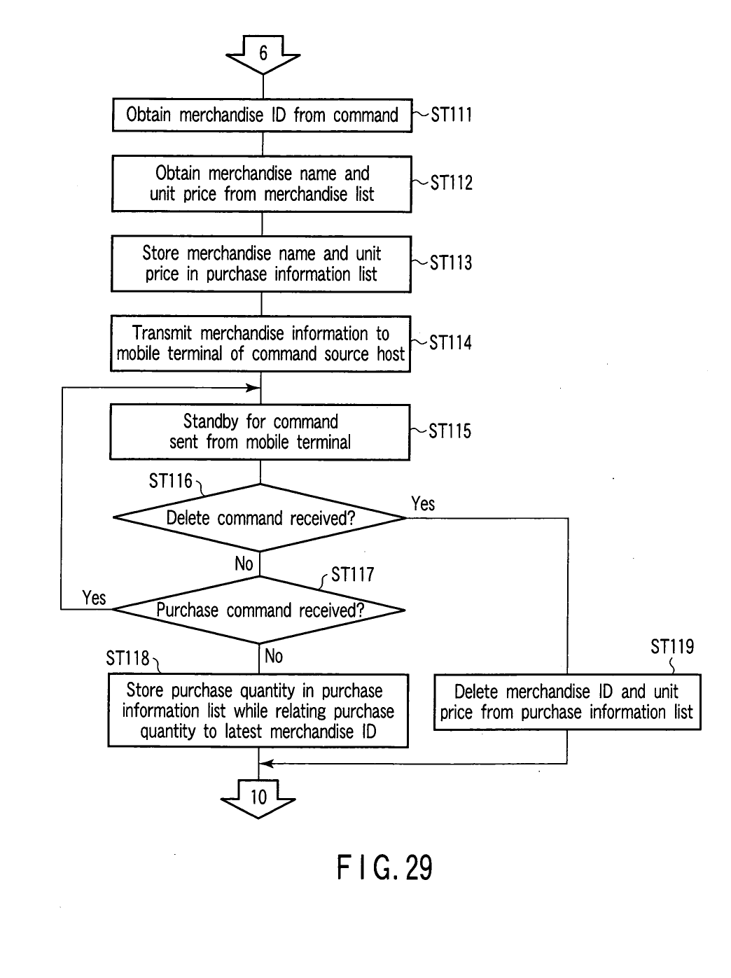

In ST 98, the CPU 81 of the merchandise server 8 is in the standby state to wait for the shopping command. When receiving the shopping command (YES in step ST99), the CPU 81 performs processing shown in a flowchart of FIG. 29.

In step ST111, the CPU 81 obtains the merchandise ID from the received shopping command. In step ST112, the CPU 81 searches the merchandise list 87L using the merchandise ID, and the CPU 81 obtains the merchandise name and unit price which are related to the merchandise ID. In step ST113, the CPU 81 stores the merchandise ID and unit price in the purchase information list 85L while the relating the merchandise ID and unit price to the user ID stored in the processing in step ST97. In step ST114, the CPU 81 transmits merchandise information including the merchandise ID, merchandise name, and unit price to the mobile terminal 1 which is the source host of the shopping command. In step ST115, the CPU 81 is in the standby state to wait for the next command sent from the mobile terminal 1.

In step ST31, the CPU 21 of the mobile terminal 1 transmitting the shopping command is in the standby state to wait for the merchandise information. When receiving the merchandise information from the merchandise server 8, the CPU 21 causes the display unit 28 to display a merchandise information confirmation screen in step ST32. The merchandise name, unit price, and purchase quantity of the received merchandise information are displayed on the merchandise information confirmation screen. “1” is displayed as an initial value in the purchase quantity. Additionally, the guidance displayed on in the merchandise information confirmation screen, a “YES” button is input when the purchase quantity of “1” is acceptable, a ten-key button is input when the purchase quantity is changed, and a “NO” button is input when the purchase is canceled.

The consumer presses any one of the buttons according to the guidance. In step ST33, the CPU 21 is in the standby state to wait for the pressing of one of the buttons. When the ten-key button of a numerical value N is input (YES in step ST34), the CPU 21 determines whether or not the numerical value N is “0” in step ST35. When the numerical value N is an integer larger than “0” (YES in step ST35), the CPU 21 sets the numerical value N to the purchase quantity in step ST36. In step ST37, the CPU 21 stores the purchased merchandise information including the purchase quantity in the purchased merchandise list 31L. The purchased merchandise list 31L is cleared in the starting up the shopping program.

In step ST38, the CPU 21 causes the display unit 28 to display a purchased merchandise information screen. The consumer can understand that the purchased merchandise is determined from the purchased merchandise information screen.

In step ST39, the CPU 21 transmits a purchase command to the merchandise server 8 through the network 9. The purchase command includes the purchase quantity. After a predetermined time elapsed, the CPU 21 returns the screen of the display unit 28 to the shopping waiting instruction screen. At this point, the merchandise name of the merchandise of which the purchase is determined is displayed in the screen together with the buttons.

In the mobile terminal 1 which is in the standby state to wait for the pressing of the button in step ST33, when the mobile terminal 1 detects the pressing of the “YES” button (YES in step ST40), the CPU 21 fixes the purchase quantity to the initial value of “1” in step ST41. After the CPU 21 performs the pieces of processing in steps ST37, ST38, and ST39, the CPU 21 returns the screen of the display unit 28 to the shopping waiting instruction screen (step ST21).

On the other hand, when a “NO” button is input (NO in step ST40), or when the numerical value N is “0” (NO in step ST36), the CPU 21 causes the display unit 28 to display a cancel confirmation screen in step ST42. In a command displayed in the cancel confirmation screen, the consumer is prompted to press the “YES” button when the purchase of the merchandise whose merchandise information is displayed is canceled, and the consumer is prompted to press the “NO” button when the purchase of the merchandise is not canceled.

When the “NO” button is input (NO in step ST43), the CPU 21 returns the screen of the display unit 28 to the merchandise information confirmation screen (step ST32). When the “YES” button is input (YES in step ST43), the CPU 21 transmits a cancel command to the merchandise server 8 through the network 9 in step ST44. After this, the CPU 21 returns the screen of the display unit 28 to the shopping waiting instruction screen (step ST21).

In the CPU 81 of the merchandise server 8 which is in the standby state to wait for the command in step ST115, when the CPU 81 receives the purchase command (YES in step ST117), in step ST118, the CPU 81 stores the purchase quantity in the purchase command in the purchase information list 85L while relating the purchase quantity in the purchase command to the merchandise ID and unit price stored in the processing in step ST113. After this, the flow returns to step ST98, the CPU 81 is in the standby state to wait for the next command sent from the mobile terminal 1.

On the other hand, when receiving the cancel command (YES in step ST116), the CPU 81 clears the merchandise ID and unit price stored in the last processing in step ST113 from the purchase information list 85L in step ST119. After this, the flow returns to step ST98, the CPU 81 is in the standby state to wait for the next command sent from the mobile terminal 1.

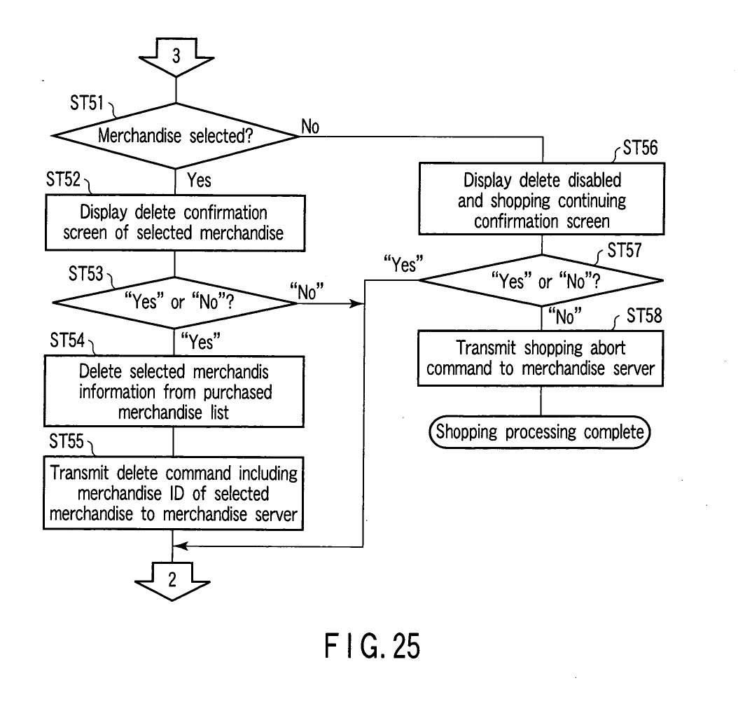

In the mobile terminal 1 which is in the standby state to wait for the pressing of the button in step ST22, when a “Delete” button is pressed (DELETE in step ST45), the CPU 21 starts processing shown in a flowchart of FIG. 25.

In step ST51, the CPU 21 determines whether or not the merchandise is selected. The list of the merchandise names stores in the purchased merchandise list 31L is displayed in the shopping waiting instruction screen. Therefore, the CPU 21 determines whether or not the “Delete” button is input while one of the merchandise names is selected from the list of the merchandise names.

When the “Delete” button is input while the merchandise name is selected (YES in step ST51), the CPU 21 causes the display unit 28 to display a delete confirmation screen in step ST52. In the command displayed on the delete confirmation screen, the consumer is prompted to press the “YES” button when the merchandise of the selected merchandise name is deleted, and the consumer is prompted to press the “NO” button when the merchandise is not deleted.

At this point, when the “NO” button is input (NO in step ST53), the CPU 21 returns the screen of the display unit 28 to the shopping waiting instruction screen (step ST21).

When the “YES” button is input (YES in step ST53), the CPU 21 deletes the selected merchandise name and the corresponding merchandise ID, unit price, and purchase quantity from the purchased merchandise list 31L in step ST54. In step ST55, the CPU 21 transmits the delete command to the merchandise server 8 through the network 9. The delete command includes the merchandise ID corresponding to the selected merchandise name. After this, the CPU 21 returns the screen of the display unit 28 to the shopping waiting instruction screen (step ST21).

On the other hand, when the “Delete” button is input while the merchandise name is not selected (NO in step ST51), the CPU 21 causes the display unit 28 to display a shopping continuing confirmation screen in step ST56. A command indicating that the delete operation is disabled is displayed in the shopping continuing confirmation screen. Additionally, in a command also displayed in the shopping continuing confirmation screen, the consumer is prompted to press the “YES” button when the shopping is continued, and the consumer is prompted to press the “NO” button when the shopping is not continued.

When the “YES” button is input (YES in step ST57), the CPU 21 returns the screen of the display unit 28 to the shopping waiting instruction screen (step ST21).

When the “NO” button is input (NO in step ST57), the CPU 21 transmits a shopping abort command to the merchandise server 8 through the network 9 in step ST58. After this, the shopping processing is ended.

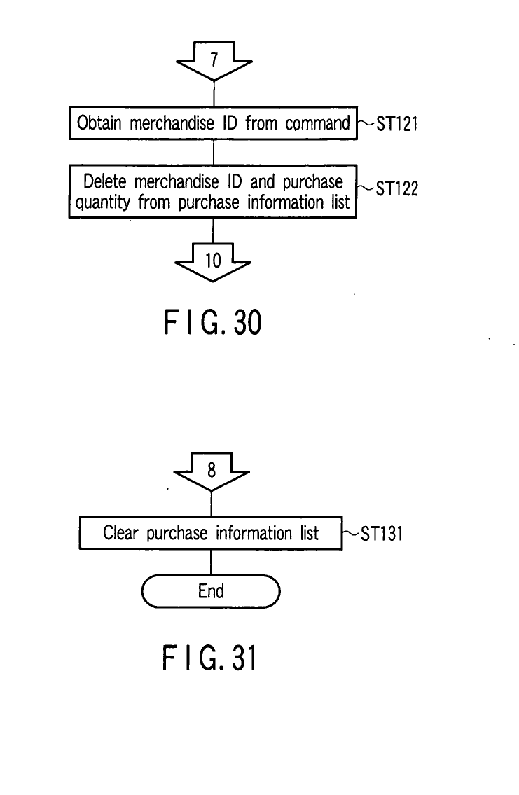

In the CPU 81 of the merchandise server 8, which is in the standby state to receive the command in step ST98, when the CPU 81 receives the delete command (YES in step ST100), the CPU 81 performs processing shown in a flowchart of FIG. 30. In step ST121, the CPU 81 obtains the merchandise ID from the received delete command. In step ST122, the CPU 81 researches the purchase information list 85L using the merchandise ID and the CPU 81 deletes the merchandise information including the merchandise ID. After this, the flow returns to step ST98, the CPU 81 is in the standby state to wait for the next command sent from the mobile terminal 1.

When receiving the shopping abort command (YES in step ST101), the CPU 81 performs processing shown in a flowchart of FIG. 31. That is, in step ST131, the CPU 81 clears all the pieces of data in the purchase information list 85L to disconnect the line with the mobile terminal 1.

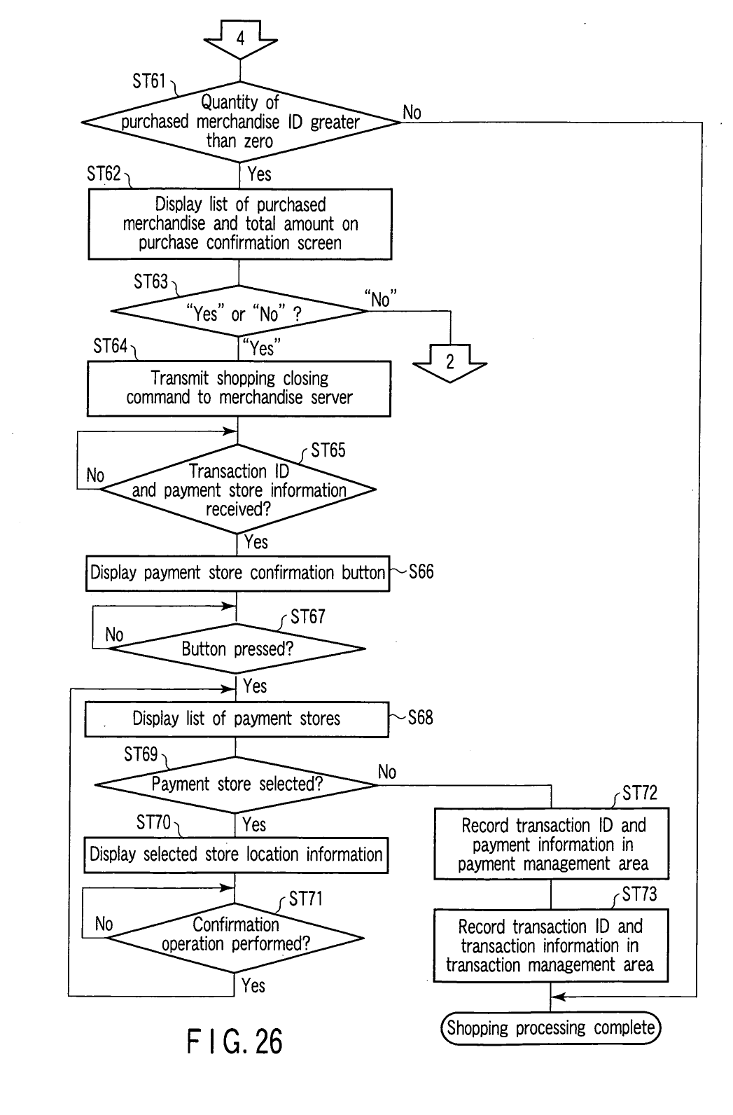

In the mobile terminal 1 which is in the standby state to wait for the pressing of the button in step ST22, when the “End” button is input (END in step ST45), the CPU 21 performs processing shown in a flowchart of FIG. 26.

In step ST61, the CPU 21 determines whether or not the number of purchased items of merchandise is greater than zero. In the case where no piece of merchandise information is stored in the purchased merchandise list 31L, the number of purchased items of merchandise is zero. In this case, the shopping program is ended.

In the case where the merchandise information is stored in the purchased merchandise list 31L, the number of purchased items of merchandise is not lower than “1”. In this case, the CPU 21 computes a payment amount from the unit price and purchase quantity stored in the purchased merchandise list 31L in step ST62. The CPU 21 causes the display unit 28 to display a purchase confirmation screen. The payment amount and the list of the merchandise names and purchase quantities stored in the purchased merchandise list 31L are displayed on the purchase confirmation screen. Additionally in a command also displayed on the purchase confirmation screen, the consumer is prompted to press the “YES” button when the purchase is confirmed, and the consumer is prompted to press the “NO” button when the purchase is canceled.

When the “NO” button is input (NO in step ST63), the CPU 21 returns the screen of the display unit 28 to the shopping waiting instruction screen (step ST21).

When the “YES” button is input (YES in step ST63), the CPU 21 transmits a closing command to the merchandise server 8 through the network 9 in step ST64.

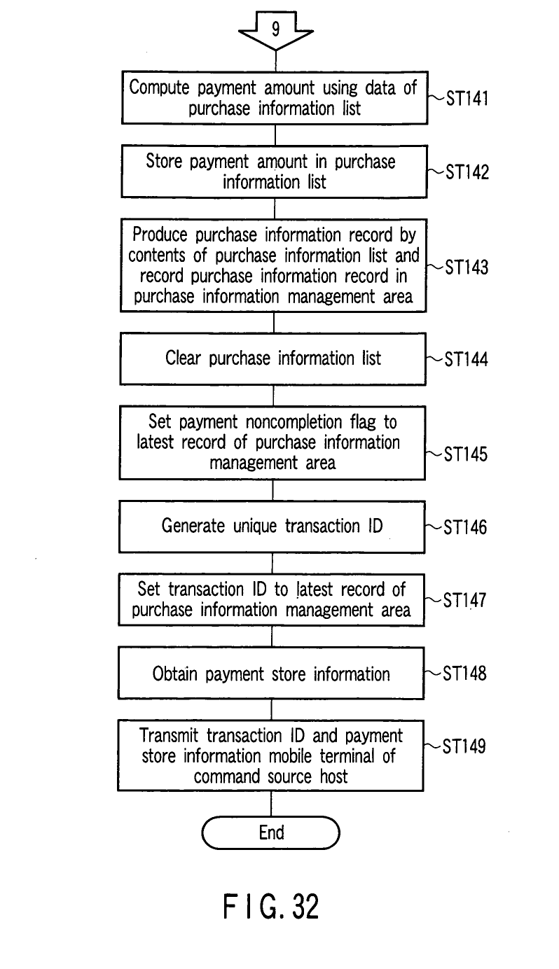

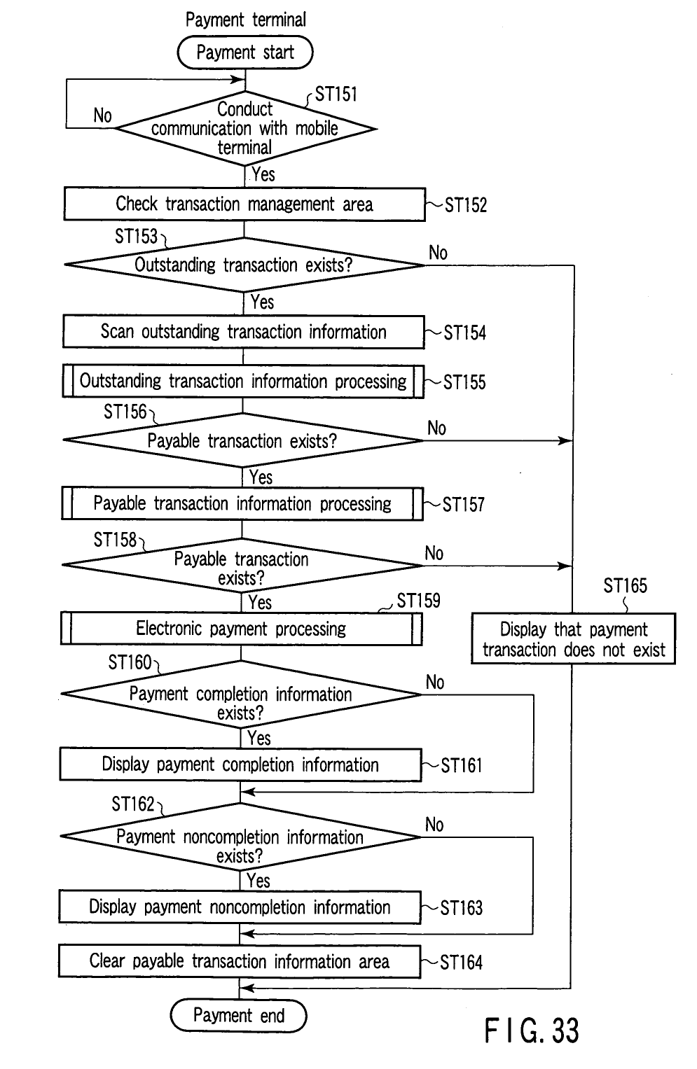

In the CPU 81 of the merchandise server 8, which is in the standby state to receive the command in step ST98, when the CPU 81 receives the closing command (YES in step ST102), the CPU 81 performs processing shown in a flowchart of FIG. 32.

In step ST141, the CPU 81 computes the payment amount. The payment amount is the total value of merchandise of the unit price and the purchase quantity of the pieces of merchandise information stored in the purchase information list 85L. In step ST142, the CPU 81 stores the payment amount in the purchase information list 85L.

In step ST143, the CPU 81 produces a purchase information record 89R using the data of the purchase information list 85L. After this, the CPU 81 records the purchase information record 89R in the purchased merchandise information management area 89. After this, in step ST144, the CPU 81 clears the purchase information list 85L.

In step ST145, the CPU 81 sets a payment noncompletion flag to the purchase information record 89R. In step ST146, the CPU 81 generates new transaction ID. In step ST147, the CPU 81 sets the new transaction ID to the purchase information record 89R.

Next, in step ST148, the CPU 81 reads all the pieces of payment store information stored in the payment store list 88L. In step ST149, the CPU 81 transmits the payment store information and the payment store information generated in the processing in step ST146 to the mobile terminal 1 which is the source host of the command. After this, the CPU 81 disconnects the line with the mobile terminal 1.

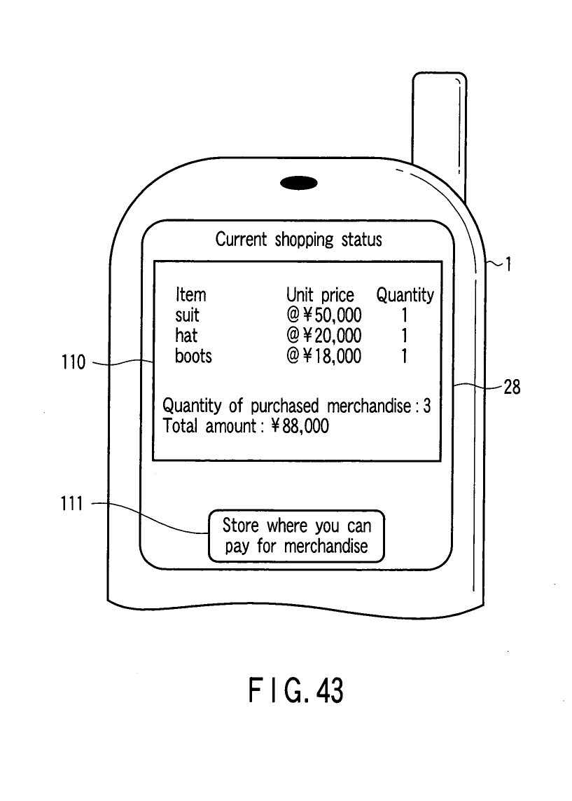

In step ST65, the CPU 21 of the mobile terminal 1 transmitting the closing command is in the standby state to wait for the response from the merchandise server 8. When receiving the transaction ID and payment store information through the network 9 (YES in step ST65), the CPU 21 causes the display unit 28 to display a payment store confirmation button on the purchase confirmation screen in step ST66. At this point, FIG. 43 shows an example of the screen in which an area 110 is the purchase confirmation screen. In FIG. 43, the area 110 is the purchase confirmation screen, and a “Payment Store Confirmation” button 111 is displayed below the screen 110.

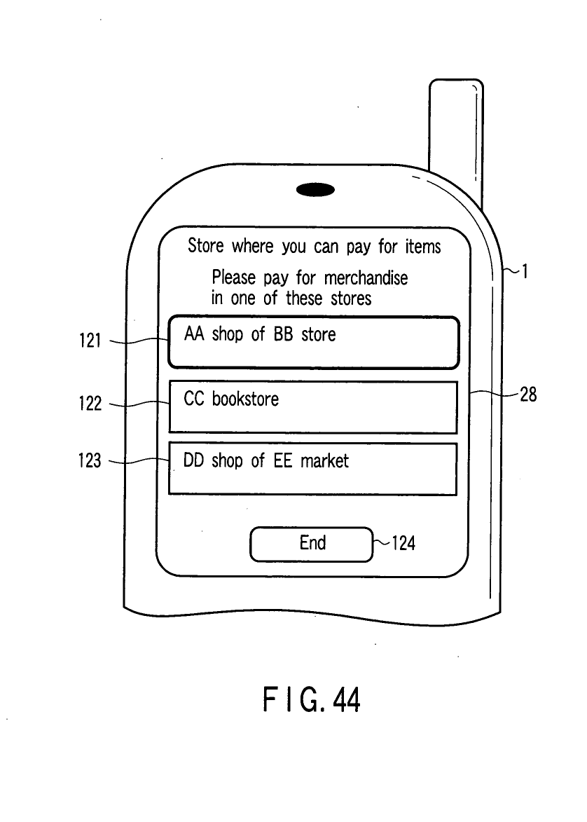

In step ST67, the CPU 21 is in the standby state to wait for the operation of the “Payment Store Confirmation” button 111. When the “Payment Store Confirmation” button 111 is input (YES in step ST67), the CPU 21 switches the screen of the display unit 28 to a payment store list screen in step ST68. A list of the store names received as the payment store information is displayed in the payment store list screen. FIG. 44 shows an example of the payment store list screen. A group of buttons 121, 122, and 123 of the store names and an “End” button 124 are displayed in the payment store list screen.

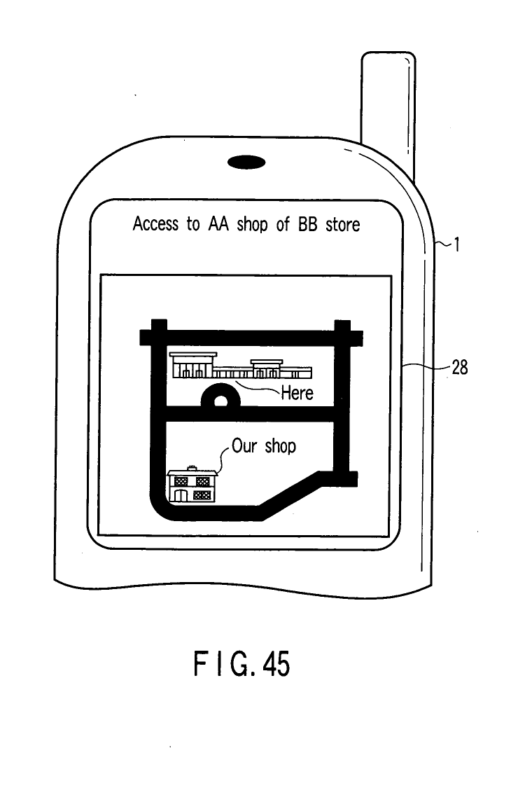

In step ST69, the CPU 21 is in the standby state to wait for the pressing of one of the buttons. When one of the store name buttons 121 to 123 is operated (YES in step ST69), the CPU 21 causes the display unit 28 to display a map in step ST70. As shown in FIG. 45, the map indicates a location relationship between the sales store SS and the selected payment store AS in the display unit 28. When the confirmation operation is performed in step ST71, the CPU 21 returns the screen of the display unit 28 to the payment store list screen (step ST68).

When the “End” button 124 is input in displaying the payment store list screen (NO in step ST69), the CPU 21 produces a payment information management record 33R to record the payment information management record 33R in the payment information management area 33 in step ST72. The record 33R includes the transaction ID received by the processing in step ST65, the sales store ID obtained by the processing in step ST4, the payment amount computed by the processing in step ST62, the payment noncompletion flag, all the payment store ID in the payment store information received by the processing in step ST65, and the data of the purchased merchandise list 31L.

In step ST73, the CPU 21 produces a transaction management record 36R to record the transaction management record 36R in the transaction management area 36. The transaction management record 36R includes the transaction ID received by the processing in step ST65, the sales store ID obtained by the processing in step ST4, the payment amount computed by the processing in step ST62, all the payment store ID in the payment store information received by the processing in step ST65, and the payment noncompletion flag. With all above, the shopping processing is ended.

When the shopping processing is ended, the CPU 21 switches the screen of the display unit 28 to a predetermined shopping end screen in step ST16. After this, the shopping program is ended.

Thus, when the consumer purchases merchandise item A in the store window 100 outside opening hours of the sales store SS, the consumer firstly scans the two-dimensional data code symbol M1 using the mobile terminal 1, which displays the store name of the sales store SS on the mobile terminal 1. The consumer confirms whether or not the store name is correct.

When the store name is correct, the consumer inputs the shopping. After this, approval whether or not the consumer is the user is given. When the approval is given, the consumer presses the shopping button, and further scans the two-dimensional data code symbol M2 of merchandise item A. Therefore, the merchandise name and unit price of merchandise item A are displayed on the mobile terminal 1. The consumer confirms whether or not the merchandise name and the unit price are corrected.

When the merchandise name and the unit price are corrected, the consumer inputs the purchase quantity if needed and the consumer presses the “YES” button. Therefore, the merchandise ID, merchandise name, unit price, and purchase quantity of merchandise item A are stored in the purchased merchandise list 31L. At the same time, the purchased merchandise information screen is displayed on the display unit 28 of the mobile terminal 1. The consumer understands that the purchase of merchandise item A is determined from the purchased merchandise information screen.

After this, the screen of the mobile terminal 1 is switched to the shopping waiting instruction screen. At least the merchandise names of the purchased merchandise list 31L are displayed on the shopping waiting instruction screen.

When the purchase of the merchandise is determined, the mobile terminal 1 transmits the purchase command to the merchandise server 8 of the sales store SS. When the merchandise server 8 receives the purchase command, the merchandise server 8 stores the merchandise ID, unit price, and purchase quantity of the purchased merchandise together with the user ID of the consumer in the purchase information list 85L.

After this, when the consumer purchases another merchandise, the consumer presses the shopping button again to scan the two-dimensional data code symbol M2 of the desired merchandise. Therefore, the same processing is performed.

In the case where the consumer cancels a part of the purchased merchandise, the consumer selects the merchandise name of the merchandise to be canceled from the merchandise names displayed on the shopping waiting instruction screen, and then presses the “Delete” button. Therefore, the information on the merchandise selected from the purchased merchandise list 31L is deleted. The mobile terminal 1 transmits the delete command to the merchandise server 8 of the sales store SS.

When the merchandise server 8 receives the delete command, the merchandise server 8 deletes the data of the selected merchandise from the pieces of data which are stored in the purchase information list 85L while related to the user ID of the consumer.

In the case where the consumer cancels the purchase of all the merchandise, the consumer does not selects the merchandise name but presses the “Delete” button. Therefore, the mobile terminal 1 transmits the shopping abort command to the merchandise server 8 of the sales store SS.

When the merchandise server 8 receives the shopping abort command, the merchandise server 8 deletes all the pieces of data which are stored in the purchase information list 85L while related to the user ID of the consumer.

In any case, because the confirmation operation is required before the data is deleted, the data is not mistakenly deleted.

When the shopping is ended in the sales store SS, the consumer presses the “End” button on the shopping waiting instruction screen, which allows the purchase confirmation screen 110 to be displayed. The consumer presses the “YES” button when everything is satisfactory. Therefore, the mobile terminal 1 transmits the closing command to the merchandise server 8 of the sales store SS.

When the merchandise server 8 receives the closing command, the merchandise server 8 produces the outstanding purchase information record 89R from the data of the purchase information list 85L and the merchandise server 8 records the outstanding purchase information record 89R in the purchased merchandise information management area 89. The new transaction ID is added to the purchase information record 89R.

The merchandise server 8 reads the information on all the payment stores AS in which the representation payment for the sales store SS can be performed from the payment store list 88L. The merchandise server 8 transmits the information on the payment store and the new transaction ID to the mobile terminal 1 which is the source host of the command.

When the mobile terminal 1 receives the payment store information and the transaction ID from the merchandise server 8, the mobile terminal 1 displays the payment store confirmation button 111 on the display unit 28 (see FIG. 43). When the payment store confirmation button 111 is input, the list of the payment stores AS is displayed on the display unit 28 (see FIG. 44).

The consumer selects the store in which the consumer pays for the merchandise purchased in the sales store SS. If the consumer presses the button 121 of “AA place of BB store”, the guide map from the sales store SS to “AA place of BB store” is displayed as shown in FIG. 45.

Because the display unit 28 of the mobile terminal 1 has the small screen, it is difficult to display the list of the payment stores AS in one screen. Therefore, desirably an order of priority is set to the payment stores AS, and the payment stores AS are displayed according to the order of priority. The following three methods can be cited as the method for determining the order of priority. In the first method, the payment stores AS are displayed in the order in which the payment store AS is located closer to the sales store SS. In the second method, the payment stores AS having the affiliated service such as the issue of coupon are preferentially displayed. In the third method, the information on the payment stores AS utilized by the user in the past are recorded in the nonvolatile memory 23 of the mobile terminal 1, and the payment stores AS are displayed in order descending usage frequency.

When the consumer confirms the payment store AS, the consumer goes to the store AS to pay for the merchandise. At this point, the transaction management record 36R is stored in the transaction management area 36 of the mobile terminal 1 while related to the unique transaction ID generated by the merchandise server 8 of the sales store SS. The store ID of the sales store SS, the store ID list of all the payment stores AS having the payment affiliated relationship with the sales store SS, and the payment noncompletion flag are set in the In the transaction management record 36R. The payment information management record 33R is recorded in the payment information management area 33 while related to the same transaction ID. The store ID of the sales store SS, the store ID list of the payment stores AS, the payment amount, the purchased merchandise list, and the payment noncompletion flag are set in the payment information management record 33R.

On the other hand, in the merchandise server 8 of the sales store SS, the purchase information record 89R is recorded in the purchase information management area 89 while related to the user ID of the consumer. The same information as the payment information management record 33R is set in the purchase information record 89R.

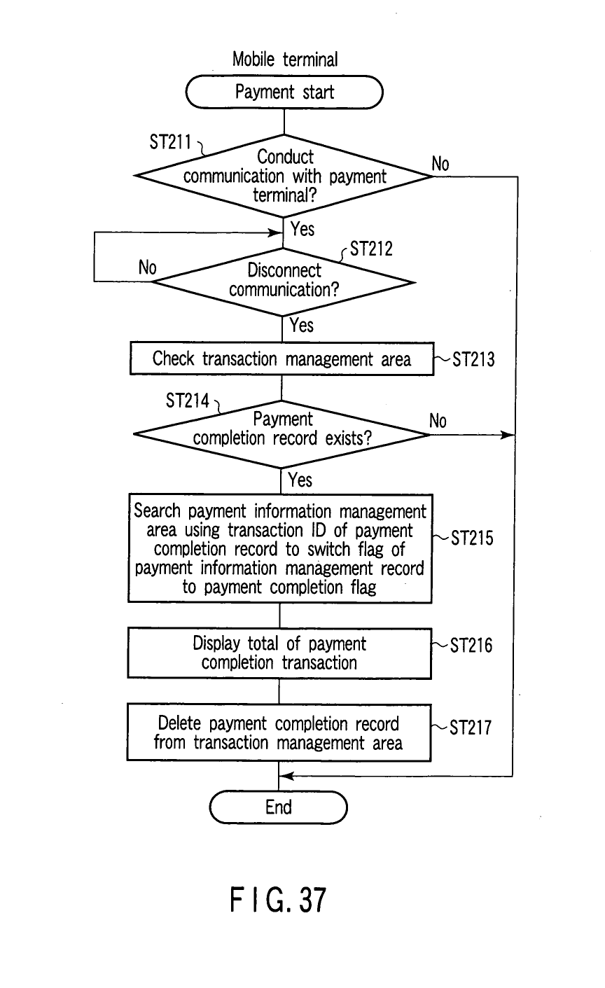

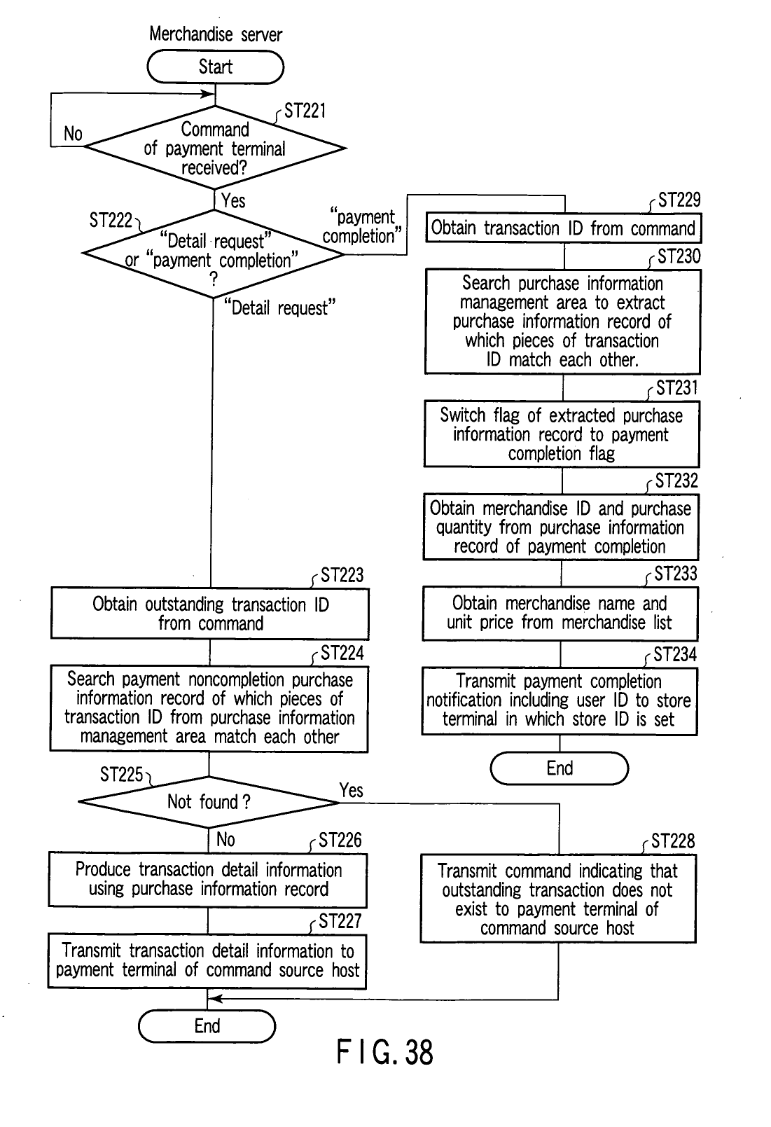

The consumer who goes to the payment store AS offers a sales clerk to pay for the merchandise purchased in the sales store SS by electronic money of the mobile terminal 1. The sales clerk operates the input unit 50 of the payment terminal 2 to declare the start of the electronic payment. The CPU 41 controls each unit in the procedures shown in the flowcharts of FIGS. 33 to 36 according to an electronic payment corresponding program resident in the nonvolatile memory 43. The CPU 21 of the mobile terminal 1 controls each unit in the procedure shown in the flowcharts of FIG. 37, and the CPU 81 of the merchandise server 8 controls each unit in the procedure shown in the flowchart of FIG. 38. The case, in which the payment is performed by the consumer, will be described below with reference to the flowcharts of FIG. 33 to 38.

When the electronic payment start is declared, the CPU 41 of the payment terminal 2 is in the standby state to enables the wireless communication with the mobile terminal using the contactless IC card in step ST151. The consumer brings the contactless IC card interface 26 of the mobile terminal 1 close to the contactless IC card interface 46 of the payment terminal 2, which enables the wireless communication using the contactless IC card.

When the wireless communication is enabled (YES in step ST151), the CPU 41 checks the transaction management area 36 stored in the contactless IC card memory 27 of the mobile terminal 1 in step ST152.

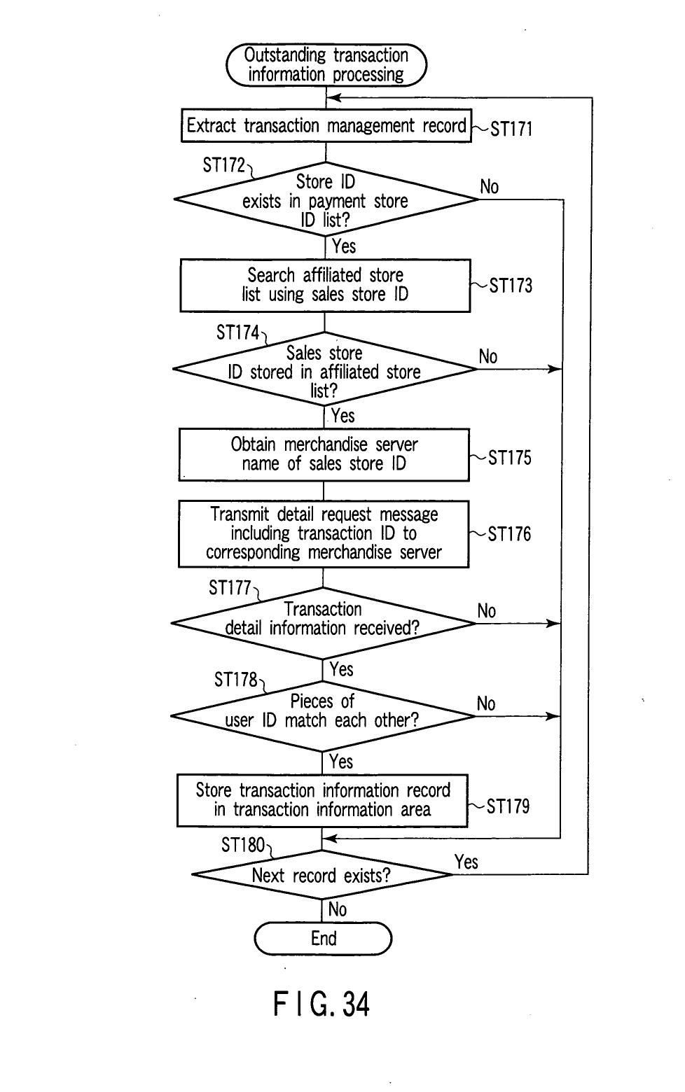

When the transaction management record 36R is stored in the transaction management area 36 (YES in step ST153), the CPU 41 reads the whole of the record 36R though the wireless communication in step ST154. In step ST155, the CPU 41 performs outstanding transaction information processing specifically shown by the flowchart of FIG. 34.

That is, the CPU 41 extracts one by one the transaction management record 36R read from the mobile terminal 1 (step ST171), and the CPU 41 performs the pieces of processing in step ST172 to step ST179 in each case. In step ST172, the CPU 41 determines whether or not the store ID in the store ID area 54 exists in the payment store ID list of the extracted record 36R. When the store ID exists in the payment store ID list, flow goes to processing in step ST173.

In step ST173, the CPU 41 searches the affiliated store list 55L using the sales store ID of the record 36R. In step ST174, the CPU 41 determines whether or not the sales store ID is stored in the affiliated store list 55L. When the sales store ID is stored in the affiliated store list 55L, the flow goes to processing in step ST175.

In step ST175, the CPU 41 obtains the server name which is stored while related to the sales store ID from the affiliated store list 55L. In step ST176, the CPU 41 transmits a detail request command through the network 9 to the merchandise server 8 in which the server name is set. The detail request command includes the transaction ID of the extracted record 36R.

When receiving the detail request command, the CPU 81 of the merchandise server 8 performs pieces of processing in steps ST221 to ST228 of FIG. 38. When the CPU 81 first confirms that the command is received from the payment terminal 2 in step ST221, the CPU 81 distinguishes between the detail request command and the payment completion command in step ST222.

In this case, because of the detail request command, the CPU 81 obtains the transaction ID from the detail request command in step ST223. In step ST224, the CPU 81 searches the purchase information management area 89.

When the pieces of transaction ID match each other while purchase information record 89R in which the payment noncompletion flag is set is detected (NO in step ST225), the CPU 81 produces transaction detail information from the user ID, payment amount, and purchased merchandise information of the purchase information record 89R in step ST226. In step ST227, the CPU 81 transmits a response command including the transaction detail information through the network 9 to the payment terminal 2 which is the source host of the command.

As a result of searching the purchase information management area 89, when the corresponding purchase information record 89R cannot be detected (YES in step ST225), the CPU 81 transmits the response command indicating that outstanding transaction does not exist through the network 9 to the payment terminal 2 which is the source host of the command.

The CPU 41 of the payment terminal 2, which transmits the detail request command, is in the standby state to wait for the response command sent from the merchandise server 8. When receiving the response command including the transaction detail information (YES in step ST177), the CPU 41 determines whether or not the user ID included in the transaction detail information is matched with the user ID stored in the contactless IC card memory 27 of the mobile terminal 1 in the wireless communication state in step ST178.

When the pieces of user ID are match with each other (YES in step ST178), the CPU 41 produces a transaction information record 52R to store the transaction information record 52R in the transaction information area 52 in step ST179. The transaction information record 52R includes the transaction ID of the extracted transaction management record 36R, the payment noncompletion flag, the server name obtained from the affiliated store list 55L by the processing in step ST175, and the payment amount and purchase merchandise list of the transaction detail information sent back from the merchandise server 8. After this, in step ST180, the CPU 41 determines whether or not the next record exists. When the next record exists, the CPU 41 extracts the transaction management record 36R to perform the same processing.

When the store ID in the store ID area 54 does not exist in the payment store ID list of the transaction management record 36R extracted in the processing in step ST172 (NO in step ST172), at this point, the CPU 41 extracts the next transaction management record 36R at that time to perform the same processing.

As a result of searching the affiliated store list 55L by the processing in step ST173, when the sales store ID is not stored (NO in step ST174), when the response command sent from the merchandise server 8 is the response command indicating that the outstanding transaction does not exist (NO in step ST177), and also when the pieces of user ID are not matched with each other (NO in step ST178), the CPU 41 also extracts the next transaction management record 36R at that time to perform the same processing.

When the CPU 41 performs the processing to all the transaction management records 36R read from the mobile terminal 1 (NO in step ST180), the CPU 41 ends the outstanding transaction information processing.

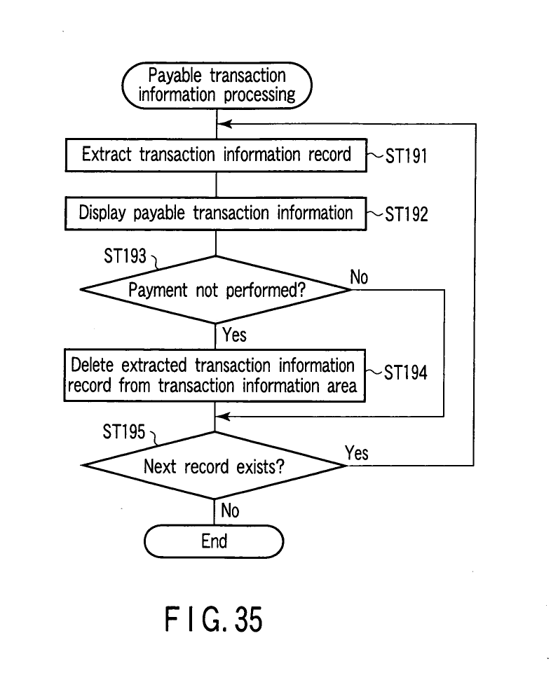

In step ST156, the CPU 41 determines whether or not the transaction information record 52R is stored in the transaction information area 52. When the transaction information record 52R is stored in the transaction information area 52, in step ST157 the CPU 41 performs payable transaction information processing specifically shown by the flowchart of FIG. 35.

That is, the CPU 41 extracts one by one the transaction information record 52R stored in the transaction information area 52 (step ST191), and the CPU 41 performs the pieces of processing in steps ST192 to ST194 in each case. In step ST192, the CPU 41 causes the operator display unit 49 and a consumer display unit 50 to display the purchased merchandise list and payment amount of the record 52R. In step ST193, the CPU 41 is in the standby state to wait for which “payment is not performed” or “payment is performed” is selected.

When “payment is not performed” is selected through the input unit 50 (YES in step ST193), the CPU 41 deletes the extracted transaction information record 52R from the transaction information area 52 in step ST194. After this, in step ST195, the CPU 41 determines whether or not the next record exists. When the next record exists, the CPU 41 extracts the transaction information record 52R to perform the same processing.

When “payment is performed” is selected through the input unit 50 (NO in step ST193), the flow goes to processing in step ST195. That is, in step ST195, the CPU 41 does not delete the extracted transaction information record 52R from the transaction information area 52.

When the CPU 41 performs the processing to all the transaction information records 52R in the payable transaction information area 52 (NO in step ST195), the CPU 41 ends the payable transaction information processing.

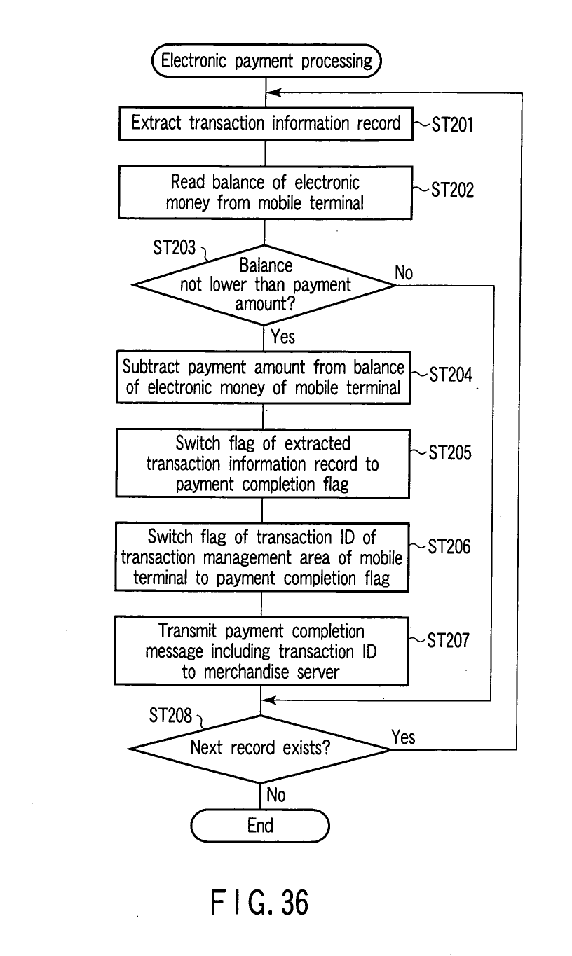

In step ST158, the CPU 41 determines whether or not the transaction information record 52R remains in the transaction information area 52. When the transaction information record 52R remains in the transaction information area 52, in step ST159 the CPU 41 performs electronic payment processing specifically shown in the flowchart of FIG. 36.

The CPU 41 extracts one by one the transaction information record 52R stored in the transaction information area 52 (step ST201), and the CPU 41 performs the pieces of processing in steps ST202 to ST207 in each case. In step ST202, the CPU 41 reads balance data of the electronic money stored in the contactless IC card memory 27 of the mobile terminal 1. In step ST203, the CPU 41 determines whether or not the balance is not lower than the payment amount of the extracted transaction information record 52R.

When the balance is not lower than the payment amount (YES in step ST203), the payment can be performed. In this case, the CPU 41 subtracts the value corresponding to the payment amount from the electronic money area 35 of the mobile terminal 1 in step ST204. In step ST205, the CPU 41 switches the flag of the extracted transaction information record 52R from the payment noncompletion flag to the payment completion flag.

In step ST206, the CPU 41 searches the transaction management record 36R whose transaction ID is matched with the transaction ID of the extracted transaction information record 52R in the records 36R stored in the transaction management area 36 of the mobile terminal 1. The CPU 41 switches the flag of the record 36R from the payment noncompletion flag to the payment completion flag.

In step ST207, the CPU 41 transmits a payment completion command through the network 9 to the merchandise server 8 which is set to the server name of the extracted transaction information record 52R. The payment completion command includes the transaction ID of the transaction information record 52R.

In step ST203, when the balance of the electronic money is lower than the payment amount, the payment cannot be performed. In this case, the CPU 41 does not perform the pieces of processing in steps ST204 to ST207.

In step ST208, the CPU 41 determines whether or not the next record exists. When the next record exists, the CPU 41 extracts the transaction information record 52R to perform the same processing. When the same processing is performed to all the transaction information records 52R in the transaction information area 52, the electronic payment processing is ended.

In step ST160, the CPU 41 determines whether or not the transaction information record 52R in which the payment completion flag is set to the transaction information area 52 exists. When the transaction information record 52R in which the payment completion flag is set to the transaction information area 52 exists, in step ST161 the CPU 41 causes the customer display unit 49 and an input unit 50 to display that the payment is completed to the purchased merchandise list and payment amount of the record 52R.

In step ST162, the CPU 41 determines whether or not the transaction information record 52R in which the payment noncompletion flag is set to the transaction information area 52 exists. When the transaction information record 52R in which the payment noncompletion flag is set to the transaction information area 52 exists, in step ST163 the CPU 41 causes the customer display unit 49 and an input unit 50 to display that the payment is not completed to the purchased merchandise list and payment amount of the record 52R.

After this, in step ST164, the CPU 41 clears the transaction information area 52. After this, the current electronic payment processing is ended.

When the transaction management record 36R is not stored in the transaction management area 36 in step ST153, CPU 11 causes the customer display unit 49 and an input unit 50 to display that the transaction to be paid does not exist in step ST165.

When the transaction information record 52R is not stored in the transaction information area 52 in step ST156, and also when the transaction information record 52R does not remain in the transaction information area 52 in step ST158, CPU 11 causes the customer display unit 49 and an input unit 50 to display that the transaction to be paid does not exist. After this, the current electronic payment processing is ended.

In step ST211, the CPU 21 of the mobile terminal 1 in which the electronic payment mode is selected is in the standby state to enable the wireless communication with the payment terminal 2 using the contactless IC card. When the wireless communication can be conducted, the CPU 21 is in the standby state to wait for the disconnection of the wireless communication state in step ST212. When the mobile terminal 1 is separated from the payment terminal 2 to disconnect the wireless communication state, the CPU 21 determines whether or not the transaction management record 36R in which the payment completion flag is stored in the transaction management area 36 in step ST213.

When the transaction management record 36R in which the payment completion flag is stored in the transaction management area 36 (YES in step ST214), the payment is completed by the electronic money to the transaction identified by the transaction ID of the record 36R. In this case, the CPU 21 obtains the transaction ID from the transaction management record 36R in step ST215. The CPU 21 searches the payment information management area 33 using the transaction ID, and the CPU 21 switches the flag of the payment information management record 33R in which the same transaction ID is set from the payment noncompletion flag to the payment completion flag.

In step ST216, the CPU 21 sums up the payment amounts of all the payment information management records 33R whose flags are switched. The total amount is displayed as the payment completion amount on the display unit 28. After this, in step ST217, the CPU 21 deletes the transaction management record 36R in which the payment completion flag is set from the transaction management area 36. With all above, the processing in the electronic payment mode is ended.

When the transaction management record 36R in which the payment completion flag is not stored in the transaction management area 36 (NO in step ST214), the processing in the electronic payment mode is ended without performing the pieces of processing in steps ST215 to SR217.

The CPU 81 of the merchandise server 8, which receives the payment completion command sent from the payment terminal 2 through the network 9, performs pieces of processing in steps ST229 to ST234 of FIG. 38. When the CPU 81 confirms that the command received in step ST222 is the payment completion command, the CPU 81 obtains the transaction ID from the payment completion command in step ST229.

In step ST230, the CPU 81 searches the purchase information management area 89 to extract the purchase information record 89R whose transaction ID is matched. In step ST231, the CPU 81 switches the flag of the purchase information record 89R from the payment noncompletion flag to the payment completion flag.

In step ST232, the CPU 81 obtains the merchandise ID and purchase quantity from the purchase information record 89R whose flag is switched to the payment completion flag. In step ST233, the CPU 81 searches the merchandise list 87L using the obtained merchandise ID, and the CPU 81 obtains the merchandise name and unit price which are related to the merchandise ID.

In step ST234, the CPU 81 produces a payment completion notification command. The payment completion notification command includes the user ID of the purchase information record 89R and payment completion merchandise information on the merchandise name, unit price, and purchase quantity. The CPU 81 transmits the payment completion notification command through the network 9 to the store terminal 3 having the store ID stored in the store ID area 86.

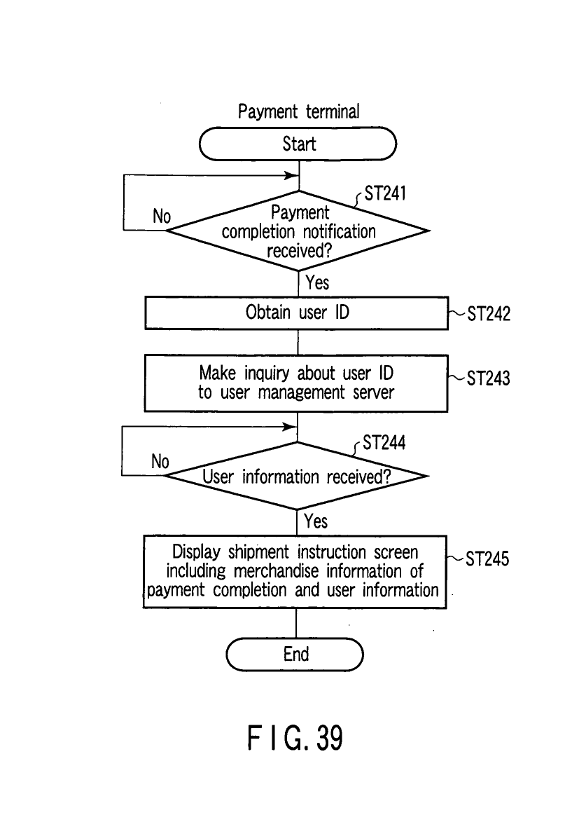

When receiving the payment completion notification command sent from the merchandise server 8 through the network 9, the CPU 41 of the payment terminal 2 performs processing shown in a flowchart of FIG. 39. When the CPU 41 confirms that the received command is the payment completion notification command in step ST241, the CPU 41 obtains the user ID from the payment completion notification command in step ST242. In step ST243, the CPU 41 accesses the user management server 6 to make an inquiry about the user information such as the user name corresponding to the user ID.

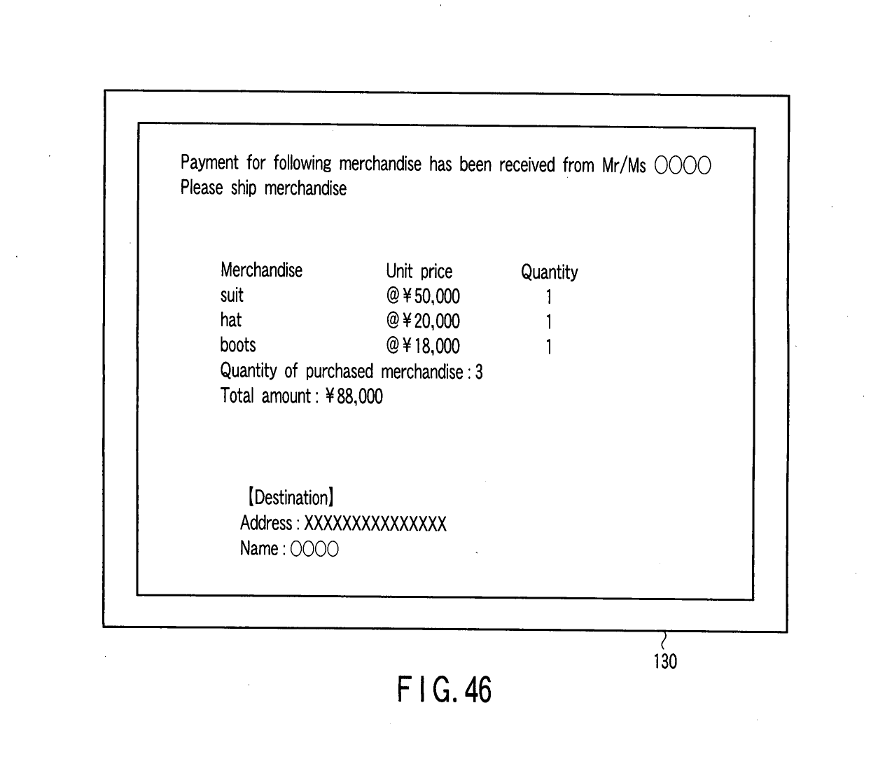

When the CPU 41 receives the user information from the user management server 6 (YES in step ST244) in response to the inquiry, the CPU 41 causes the display unit 48 of the payment terminal 2 to display the payment completion merchandise information included in the payment completion notification command together with the user information in step ST245. FIG. 46 shows an example of the display screen 130 at this point.

Thus, the consumer who goes to the payment store AS sets the operation mode of the mobile terminal 1 to the electronic payment mode. After this, the consumer brings the contactless IC card interface 26 of the mobile terminal 1 close to the contactless IC card interface 46 of the payment terminal 2.

Therefore, the wireless communication is conducted between the mobile terminal 1 and the payment terminal 2, the amount charge of the merchandise, which the consumer purchases in the sales store SS, is paid by the electronic money.

At this point, in each transaction management record 36R read from the transaction management area 36 of the mobile terminal 1, the payment terminal 2 checks whether or not the store ID of the payment store AS in which the payment terminal 2 is installed exists in the payment store ID list of the transaction management record 36R. The payment terminal 2 also checks whether or not the sales store ID in the transaction management record 36R exists in the group of pieces of sales store ID set in the affiliated store list 55L of the payment terminal 2.

When the store ID exists in the payment store ID list, and when the sales store ID exists in the affiliated store list 55L, the payment processing is performed to the payment amount in the transaction management record 36R by the electronic money.

Accordingly, in the payment store AS, the payment is performed to only the merchandise which is purchased in the sales store SS previously having the affiliated relationship regarding the payment. The payment is not performed to the merchandise which is purchased in the sales store SS having no affiliated relationship.

When the payment is completed in the payment store AS, the store terminal 3 of the sales store SS is notified of the information on the payment completion. When the store terminal 3 receives the notification, contents of the notification are displayed on the screen 130 of the display unit 48 as shown in FIG. 46. Accordingly, in the sales store SS, the procedure of the merchandise shipment can be performed according to the contents displayed on the screen 130.

Thus, according to the embodiment, the merchandise, which is sold in the physical retail store SS and displayed in the store window, can be purchased outside opening hours of the physical retail store SS using the mobile terminal 1. Additionally, the payment can be performed in another payment store AS such as the convenience store which is opened outside opening hours of the physical retail store SS. Accordingly, the restriction that the operation is continued at the counter outside opening hours is eliminated on the side of the sales store SS, so that advantageously the cost such as the personnel expenses and the utility costs can be eliminated.

On the other hand, in the payment store AS, because the payment of the merchandise purchased in the sales store SS is processed during opening hours, the personnel expenses and the utility costs are not excessively increased. The customer who purchases the merchandise in the sales store SS possibly purchases the merchandise of the payment store AS when coming in the payment store AS to perform the payment, so that sales increase can be expected.

The consumer who purchases the merchandise in the sales store SS can select the desired payment store AS from the plural payment stores AS having the affiliated relationship regarding the payment with the sales store SS, and go to the selected payment store AS to pay for the purchased merchandise. Accordingly, the consumer can flexibly and conveniently select the payment site.

Additionally, when the consumer specifies one of the payment stores AS on the payment store confirmation screen in which the list of the payable store names is displayed, the guide map to the specified payment store AS is displayed on the screen, so that the consumer can easily know the road to the store determined as the payment site. Thus, the detailed service can be provided to the consumer.

In the embodiment, when the payment is completed in the payment terminal 2, the information on the payment completion is transmitted to the store terminal 3 of the corresponding sales store SS, and the screen 130 is displayed. Accordingly, in the sales store SS, the consumer and the merchandise purchased outside opening hours can be specified and perform the procedure of the shipment from the screen 130 during opening hours.

The invention is not limited to the embodiment, but various modifications can be made without departing from the scope of the invention.

In the embodiment, the merchandise is purchased from the store window of one store. For example, in a shopping center, sometimes the plural stores display merchandise in the one store window. In such cases, the two-dimensional data code symbol M1 including the store identification code and the two-dimensional data code symbol M2 including the merchandise identification code may add to each merchandise. In this case, one two-dimensional data code symbol including the store identification code and the merchandise identification code is added to each merchandise. Therefore, the number of symbols can be decreased.

In the embodiment, the merchandise server 8 is provided in each sales store SS. Alternatively, the merchandise list 87L and the payment store list 88L are managed in each sales store SS by one server, whereby the merchandise server 8 can be shared by sales stores SS. The number of servers can be decreased by appropriately combining the functions for the program delivery server 4, the affiliated relationship management server 5, the user management server 6, and the store management server 7. For example, the affiliated relationship management server 5 and the user management server 6 may be constructed by one server.

In the embodiment, the electronic payment by the electronic money is used as the payment method in the payment terminal 2. However, the payment method is not limited to the electronic payment. For example, payment in cash, payment in credit, and prepaid payment may be adopted.

In the embodiment, the function for implementing the invention is previously recorded in the apparatus. Alternatively, the same function may be downloaded to the apparatus through the network, or the same function may be installed to the apparatus from a recording medium. Any recording medium such as CD-ROM may be used as long as the program can be recorded and read by the apparatus. The function obtained by the pre-install or download may be realized by cooperating with OS (Operating System) in the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A shopping system comprising:
a mobile terminal;
a payment terminal; and
a server which is connected to the mobile terminal and the payment terminal through a network,
wherein the mobile terminal comprises:
a payment communication unit configured to conducts data communication with the payment terminal;
an input unit configured to input a merchandise identification code to identify a merchandise;
a transmission unit configured to transmit the merchandise identification code input through the input unit to the server;
a reception unit configured to receive unique transaction identification code and payment store information transmitted from the server;
a display unit configured to display guide information of stores based on the payment store information received by the reception unit, payment for a merchandise identified by the merchandise identification code input through the input unit being able to be performed in the stores; and
a storage unit configured to store the transaction identification code received by the reception unit,
wherein the server comprises:
a merchandise information storage unit configured to store merchandise information while relating the merchandise identification code of each merchandise;
a payment store information storage unit configured to store payment store information, the payment store information indicating stores in which payment for the each merchandise can be performed;
a merchandise information obtaining unit configured to obtain the merchandise information related to the merchandise identification code from the merchandise information storage unit, when the merchandise information obtaining unit receives the merchandise identification code from the mobile terminal;
a code generation unit configured to generate the transaction identification code;
a payment information retaining unit configured to retain the merchandise information obtained by the merchandise information obtaining unit while relating the transaction identification code generated by the code generation unit;
an outstanding information transmission unit configured to transmit the transaction identification code generated by the code generation unit to the mobile terminal together with the payment store information stored in the payment store information storage unit;
a merchandise information detection unit configured to detect the merchandise information retained while related to the transaction identification code from the payment information retaining unit, when the merchandise information detection unit receives a request command of the merchandise information including the transaction identification code from the payment terminal; and
a merchandise information transmission unit configured to transmit the merchandise information detected by the merchandise information detection unit to the payment terminal, and
wherein the payment terminal comprises:
a mobile communication unit configured to conduct data communication with the mobile terminal;
a mobile terminal information obtaining unit configured to obtain the transaction identification code stored in the mobile terminal through the mobile communication unit;
a merchandise information request unit configured to transmit the request command of the merchandise information to the server, the merchandise information including the transaction identification code obtained by the mobile terminal information obtaining unit; and
a payment processing unit configured to process payment based on the merchandise information received from the server.

2. The shopping system according to claim 1, wherein the input unit of the mobile terminal is configured such that a sales store identification code is input to identify a sales store,
the transmission unit of the mobile terminal is configured so as to transmit the sales store identification code input through the input unit to the server,
the storage unit of the mobile terminal is configured such that the transaction identification code received by the reception unit and payment store information are stored therein,
the merchandise information storage unit of the server is configured such that merchandise information is stored in each sales store while related to a merchandise identification code of each merchandise sold in the sales store,
the payment store information storage unit of the server is configured such that payment store information is stored in each sales store, the payment store information indicating a store in which payment for each merchandise sold in the sales store can be performed,
the merchandise information obtaining unit of the server is configured so as to obtain the merchandise information related to the merchandise identification code from the merchandise information storage unit of the sale store identified by the sales store identification code, when the merchandise information obtaining unit receives the merchandise identification code and sales store identification code from the mobile terminal,
the outstanding information transmission unit of the server is configured so as to transmit the transaction identification code generated by the code generation unit to the mobile terminal together with the payment store information stored in the payment store information storage unit of the sales store identified by the sales store identification code,
the mobile terminal information obtaining unit of the payment terminal obtains the payment store information, the payment terminal further comprises a payment determination unit configured to determine whether payment can be performed in a store where the payment terminal is installed based on the payment store information, and
the merchandise information request unit of the payment terminal transmits the request command of the merchandise information including the transaction identification code obtained by the mobile terminal information obtaining unit to the server, on condition that the payment determination unit determines that the payment can be performed.

3. The shopping system according to claim 1, wherein the display unit of the mobile terminal displays a list of payment stores in which payment for the merchandise can be performed based on the payment store information received by the reception unit, and
when any one of the payment stores is selected from the list, the display unit displays a guide map from a sales store to the payment store.

4. The shopping system according to claim 1, wherein the payment terminal further comprises a payment completion notification unit configured to transmit a payment completion command including the transaction identification code obtained by the mobile terminal information obtaining unit to the server on condition that the payment is completed by the payment processing unit,
the server further comprises:
a payment completion processing unit configured to set merchandise information to a payment completion state when receiving the payment completion command sent from the payment terminal, the merchandise information being retained in the payment information retaining unit while related to the transaction identification code included in the payment completion command; and
a payment completion determination unit configured to determine whether or not the merchandise information retained while related to the transaction identification code is in the payment completion state when receiving the request command of the merchandise information including the transaction identification code from the payment terminal, and
the merchandise information transmission unit of the server transmits merchandise information to the payment terminal, when the payment completion determination unit determining that the merchandise information is not in the payment completion state in pieces of merchandise information detected by the merchandise information detection unit.

5. The shopping system according to claim 2, wherein the mobile terminal further comprises a user storage unit configured to store a user identification code for identifying a user,
the transmission unit of the mobile terminal transmits the user identification code stored in the user storage unit to the server,
the payment information retaining unit of the server retains the merchandise information obtained by the merchandise information obtaining unit and the user identification code received from the mobile terminal while relating the merchandise information and the user identification code to the transaction identification code generated by the code generation unit,
the merchandise information transmission unit of the server transmits the merchandise information detected by the merchandise information detection unit and the user identification code retained by the payment information retaining unit together with the merchandise information to the payment terminal,
the mobile terminal information obtaining unit of the payment terminal further obtains the user identification code stored in the mobile terminal through the mobile communication unit, and
the payment processing unit of the payment terminal processes payment on condition that the user identification code received from the server is matched with the user identification code obtained from the mobile terminal.

6. The shopping system according to claim 5, wherein the payment terminal further comprises a payment completion notification unit configured to transmit a payment completion command including the transaction identification code obtained by the mobile terminal information obtaining unit to the server on condition that the payment is completed by the payment processing unit,
the server further comprises:
a payment completion processing unit configured to set merchandise information and a user identification code in a payment completion state when receiving the payment completion command sent from the payment terminal, the merchandise information and the user identification code being retained in the payment information retaining unit while related to the transaction identification code included in the payment completion command; and
a payment completion determination unit configured to determine whether or not the merchandise information and user identification code retained while related to the transaction identification code are the payment completion state when receiving the request command of the merchandise information including the transaction identification code from the payment terminal, and
the merchandise information transmission unit of the server transmits merchandise information and user identification code to the payment terminal, the payment completion determination unit determining that the merchandise information and user identification code are not in the payment completion state in pieces of merchandise information and user identification codes detected by the merchandise information detection unit.

7. The shopping system according to claim 6, further comprising a sales store terminal which is connected to the server through the network,
wherein the server further comprises:
a user information storage unit configured to store user information while related to a user identification code of each user; and
a payment information transmission unit configured to transmit the merchandise information and user identification code set in the payment completion state by the payment completion processing unit to the sales store terminal of a sales store to which the merchandise information corresponds,
the sales store terminal comprises:
a user information obtaining unit configured to access the server to obtain user information related to the user identification code when receiving the merchandise information and user identification code from the server; and
a display unit configured to display user information obtained by the user information obtaining unit and merchandise information received from the server.

8. A mobile terminal which is connected to a server through a network, the mobile terminal comprising:
a payment communication unit configured to conduct data communication with the payment terminal installed in a payment store;
an input unit configured to input a merchandise identification code for identifying a merchandise and a sales store identification code for identifying a sales store;
a transmission unit configured to transmit the merchandise identification code and sales store identification code input through the input unit to the server;
a reception unit configured to receive unique transaction identification code and payment store information transmitted from the server;
a display unit configured to display guide information of a store based on the payment store information received by the reception unit, payment for a merchandise identified by the merchandise identification code input through the input unit being able to be performed in the store; and
a storage unit configured to store the transaction identification code and payment store information received by the reception unit.

9. The mobile terminal according to claim 8, wherein the display unit displays a list of payment stores in which payment for the merchandise can be performed based on the payment store information received by the reception unit, and
when one of the payment stores is selected from the list, the display unit displays a guide map from a sales store to the payment store.

10. The mobile terminal according to claim 8, further comprising a user storage unit configured to store a user identification code for identifying a user,
wherein the transmission unit transmits the user identification code stored in the user storage unit to the server.

11. A server which is connected to a mobile terminal and a payment terminal through a network, the server comprising:
a merchandise information storage unit configured to store merchandise information in each sales store of a merchandise while related to a merchandise identification code of each merchandise sold in the sales store;
a payment store information storage unit configured to store payment store information in the each sales store, the payment store information indicating a store in which payment for the each merchandise sold in the sales store can be performed;
a merchandise information obtaining unit configured to obtain the merchandise information related to the merchandise identification code from the merchandise information storage unit of a sales store identified by a sales store identification code, when the merchandise information obtaining unit receives the merchandise identification code and the sales store identification code from the mobile terminal;
a code generation unit configured to generate the transaction identification code;
a payment information retaining unit configured to retain the merchandise information obtained by the merchandise information obtaining unit while relating the merchandise information to the transaction identification code generated by the code generation unit;
an outstanding information transmission unit configured to transmit the transaction identification code generated by the code generation unit to the mobile terminal together with the payment store information stored in the payment store information storage unit of the sales store identified by the sales store identification code;
a merchandise information detection unit configured to detect the merchandise information retained while related to the transaction identification code from the payment information retaining unit, when the merchandise information detection unit receives a request command of the merchandise information including the transaction identification code from the payment terminal; and
a merchandise information transmission unit configured to transmit the merchandise information detected by the merchandise information detection unit to the payment terminal.

12. The server according to claim 11, further comprising:
a payment completion processing unit configured to set merchandise information to a payment completion state when receiving the payment completion command sent from the payment terminal, the merchandise information being retained in the payment information retaining unit while related to the transaction identification code included in the payment completion command; and
a payment completion determination unit configured to determine whether or not the merchandise information retained while related to the transaction identification code is in the payment completion state when receiving the request command of the merchandise information including the transaction identification code from the payment terminal,
wherein the merchandise information transmission unit of the server transmits merchandise information to the payment terminal, the payment completion determination unit determining that the merchandise information is not in the payment completion state in pieces of merchandise information detected by the merchandise information detection unit.

13. The server according to claim 11, wherein the payment information retaining unit retains the merchandise information obtained by the merchandise information obtaining unit and the user identification code received from the mobile terminal while relating the merchandise information and the user identification code to the transaction identification code generated by the code generation unit, and
the merchandise information transmission unit of the server transmits the merchandise information detected by the merchandise information detection unit as well as the user identification code retained by the payment information retaining unit together with the merchandise information to the payment terminal.

14. A payment terminal which is connected to a server through a network, the payment terminal comprising:
a mobile communication unit configured to conduct data communication with a mobile terminal;
a mobile terminal information obtaining unit configured to obtain transaction identification code and payment store information stored in the mobile terminal through the mobile communication unit;
a payment determination unit configured to determine whether or not payment can be performed in a store where the payment terminal is installed based on the payment store information obtained by the mobile terminal information obtaining unit;
a merchandise information request unit configured to transmit a request command of merchandise information including the transaction identification code obtained by the mobile terminal information obtaining unit on condition that the payment determination unit determines that the payment can be performed; and
a payment processing unit configured to process payment based on the merchandise information received from the server.

15. The payment terminal according to claim 14, further comprising a payment completion notification unit configured to transmit a payment completion command including the transaction identification code obtained by the mobile terminal information obtaining unit to the server on condition that the payment is completed by the payment processing unit.

16. The payment terminal according to claim 14, wherein the mobile terminal information obtaining unit further obtains the user identification code stored in the mobile terminal through the mobile communication unit, and
the payment processing unit processes payment on condition that the user identification code received from the server is matched with the user identification code obtained from the mobile terminal.

17. A computer-readable program merchandise which causes a mobile terminal to function as a shopping instrument, the mobile terminal comprising a payment communication unit which conducts data communication with a payment terminal installed in a payment store, the mobile terminal being connected to a server through a network,
the computer-readable program merchandise causing the mobile terminal to realize:
a function of accepting inputs of a merchandise identification code for identifying a merchandise and a sales store identification code for identifying a sales store from an input unit of the mobile terminal;
a function of transmitting the merchandise identification code and sales store identification code input through the input unit to the server;
a function of receiving a unique transaction identification code and payment store information transmitted from the server;
a function of displaying guide information of a store based on the payment store information received from the server, payment for a merchandise identified by the merchandise identification code input through the input unit being able to be performed in the store; and
a function of storing the transaction identification code and payment store information received from the server in a storage unit of the mobile terminal.
